(19) United States
(12) Patent Application Publication
(10) Pub. No.: US 2026/0087620 A1
(43) Pub. Date: Mar. 26, 2026

(54) LIVER TUMOR DETECTION IN CT SCANS

(71) Applicant: Hoffmann-La Roche Inc., Little Falls, NJ (US)

(72) Inventors: Benjamin GUTIERREZ BECKER, Basel (CH); Krzysztof KOTOWSKI, Gliwice (PL); Agata KRASON, Bühler (CH); Damian Marek KUCHARSKI, Gliwice (PL); Bartosz Jakub MACHURA, Gliwice (PL); Jakub Robert NALEPA, Gliwice (PL); Jean TESSIER, Muespach (FR)

(73) Assignee: Hoffmann-La Roche Inc., Little Falls, NJ (US)

(21) Appl. No.: 19/316,770

(22) Filed: Sep. 2, 2025

Related U.S. Application Data
(63) Continuation of application No. PCT/EP2024/055666, filed on Mar. 5, 2024.

(30) Foreign Application Priority Data
Mar. 7, 2023 (EP) 23160316.8

(51) Int. Cl. G06T 7/00; G06T 7/11

(52) U.S. Cl. CPC G06T 7/0012; G06T 7/11; G06T 2207/10081; G06T 2207/20024; G06T 2207/20081; G06T 2207/30056; G06T 2207/30096

(57) ABSTRACT

The present invention relates to systems and methods of processing CT scan images comprising a liver of a subject to detect and/or predict hepatocellular carcinoma (HCC) in the subject.

### FIELD OF INVENTION

The present invention relates to systems and methods of processing CT scan images comprising a liver of a subject to detect and/or predict hepatocellular carcinoma (HCC) in the subject.

### BACKGROUND TO THE INVENTION

Hepatocellular carcinoma (HCC) is one of the most common types of liver cancers. Experts have reported a correlation between the presence of a liver disease, such as hepatitis B or C or cirrhosis, and a higher risk of contracting HCC. However, HCC can also be contracted on an otherwise healthy liver.

Ultrasound, Computed Tomography (CT) or Magnetic Resonance Imaging (MRI) scans can be used by pathologists to evaluate the presence or the likelihood of HCC in a patient. Also state-of-the-art Artificial Intelligence (AI) algorithms, in particular Machine Learning (ML) algorithms, are able to some extent to detect the presence or predict the occurrence of HCC from a medical scan.

However, the complexity of diagnosing HCC, manually or automatically, arises, amongst other factors, from the fact that different subtypes of HCC exist, which can have different enhancement patterns (Gaillard, 2021). Therefore, in order to diagnose and/or monitor HCC, the simultaneous examination of CT scan images acquired with intravenous contrast in multiple-phases CT scans, e.g. arterial-phase and venous-phase CT scans, is required. The CT scans in different phases are acquired at different points in time after contrast injection. During the time interval between said acquisition points in time, the internal organs can change their location and shape due to breathing, heartbeat, or any other movement of the patient's body. Automatic detection and prediction of HCC from multiple scans requires a perfect alignment of the two or more scan images, in particular a perfect alignment of the liver within the scan images, especially for optimally reconstructing small lesions. Moreover, automatic or manual diagnosis can be made more complex by the presence of different classes of liver lesions, such as active HCC tumors, chemoembolizations within the HCC tumors, necrosis, portal vein thrombosis, cysts, or any other lesions.

Therefore there is a need for improved systems and methods of processing CT scan images to detect and/or predict HCC.

### STATEMENTS OF INVENTION

The present invention relates to systems and methods of processing CT scan images comprising a liver of a subject to detect and/or predict HCC in the subject. These systems and methods can be used, among other applications, to diagnose HCC, to monitor HCC, to assess the risk of contracting HCC, to determine the degree of HCC disease progression, to improve the features used to characterize HCC, to stratify patients based on different HCC stages and/or characteristics, to assess the response of patients to a treatment in clinical studies, to select individuals/patients for a specific treatment or treatment regimen, to identify individuals/patients who would likely respond therapeutically to a treatment or a treatment regimen, to treat individuals/patients with HCC. Said treatment can comprise atezolizumab, bevacizumab, or a combination thereof.

The present inventors have identified that prior art methods for HCC diagnosis and monitoring are problematic because they rely on the examination of one CT scan at a time. However, HCC can manifest itself with different enhancement patterns in different CT scans. Consequently, it is impossible to obtain a reliable diagnosis without examining the results of multiple CT scans.

Moreover, in order to properly compare multiple CT scans and infer the position of HCC lesions or other objects of relevance for HCC diagnosis and monitoring, it is paramount to correctly align the multiple CT scan images, and in particular the liver therein comprised.

The invention according to the present application discloses the surprising effect that leveraging specific image analysis operations on the CT scan images, such as for example obtaining masks, and in particular liver masks, has on performing the coregistration of said CT scan images, i.e. the geometric alignment of the CT scan images so that corresponding pixels (in 2D) or voxels (in 3D) representing the same objects in the different CT scan images can be integrated or fused.

For example, using a liver mask obtained in one of the CT scan images, and in particular in the CT scan image with the highest resolution, to align the different CT scan images can result in a more precise coregistration. In precisely coregistered CT scan images, tissues that are differently contrast-enhanced in, for example, arterial-phase CT scans and venous-phase CT scans can be examined simultaneously. Analyzing the coregistered CT scan images can thus allow for an improved detection and/or prediction of lesions within the liver. Processing the CT scan images with the computer-implemented method of the present invention thus allows to diagnose and/or monitor HCC using the combined information from the multiple scans under examination.

Furthermore, the invention according to the present application discloses also the surprising effect that cropping a CT scan image using the liver mask has on performing the coregistration of the CT scan images. For example, additional organs present in the CT scan images not comprised within the liver mask can be cropped out, thus reducing the chance of misalignments or noise during coregistration.

Thus, according to a first aspect, this invention provides a computer-implemented method of processing CT scan images comprising a liver of a subject to detect and/or predict HCC in the subject, the method comprising the steps of: receiving at least two CT scan images comprising the liver; processing the received CT scan images, wherein processing comprises: selecting, from 70 the received CT scan images, a reference CT scan image; obtaining a reference liver mask for the selected reference CT scan image; coregistering the remaining at least one CT scan image with the selected reference CT scan image. The method can further comprise the step of filtering the reference CT scan image and the coregistered at least one CT scan image. The step of receiving at least two CT scan images comprising the liver can comprise receiving a CT scan image comprising the liver in arterial phase and a CT scan image comprising the liver in venous phase. The step of receiving at least two CT scan images comprising the liver can comprise receiving annotations associated with the received CT scan images comprising the liver. The step of selecting, from the received CT scan images, a reference CT scan image can comprise selecting, from the received CT scan images, the CT scan image with the highest resolution. In some embodiments, the step of selecting the CT scan image with the highest resolution can comprise selecting the CT scan image with the smallest voxel size. The step of obtaining a reference liver mask for the selected reference CT scan image can comprise using one or more algorithms configured to detect the location of the liver in the selected reference CT scan image.

A reference liver mask can comprise for each voxel in a CT scan image a first value for voxels identified as liver and a second value for voxels identified as background. The step of obtaining a reference liver mask for the selected reference CT scan image can further comprise dilating the reference liver mask. The step of dilating the reference liver mask can comprise selecting neighbouring voxels to the reference liver mask, i.e. within a certain range of voxels or within a certain distance, and identifying said neighbouring voxels as comprised in the reference liver mask. A suitable distance can be 10 mm. The method can further comprise cropping, using the obtained reference liver mask, the selected reference CT scan image. The step of coregistering the remaining at least one CT scan image with the selected, optionally cropped, reference CT scan image can comprise performing a rigid coregistration, a deformable coregistration, or any combination thereof. The step of coregistering the remaining at least one CT scan image with the selected, optionally cropped, reference CT scan image can further comprise cropping, using the obtained reference liver mask, the remaining at least one CT scan image. The method can further comprise filtering the reference CT scan image and the coregistered at least one CT scan image.

The step of filtering the reference CT scan image and the coregistered at least one CT scan image can comprise selecting the voxels that have an intensity above a certain threshold and/or rejecting voxels that have an intensity below another certain threshold. Voxel intensities in CT scan images are given in Hounsfield units (HU) and directly relate to the density of scanned objects. For example, soft tissues like liver tissues have intensities between 30 and 60 HU.

The invention according to the present application discloses the surprising effect that processing the CT scan images as hereinbefore described has on improving the coregistration of the liver within CT scan images. For example, the rigid coregistration can allow for an alignment of the liver positioned in different locations across CT scan images. The deformable coregistration can allow for an alignment of the liver characterized by different shapes across CT scan images, for example deformed by breathing. Analyzing the CT scan images coregistered with a rigid coregistration and a deformable coregistration can thus allow to integrate the information about location and shape of the liver across CT scan images. Furthermore, the invention according to the present application discloses the surprising effect that cropping a CT scan image has on obtaining in particular an improved rigid coregistration, i.e. where the liver has changed only location and not shape across CT scan images.

Furthermore, the invention according to the present application discloses the surprising effect that filtering the reference CT scan image and the coregistered at least one CT scan image has on improving the coregistration of CT scan images. For example, filtering the CT scan images using the voxel intensities in CT scan images allows for identifying voxels associated to air, fat, fluids, soft tissues, iodinated contrast, bones, and/or other dense materials. Voxel intensities in CT scan images are given in Hounsfield units (HU) and directly relate to the density of scanned objects: air (−1000 HU), fat (between −150 HU and −50 HU), fluids (between −10 HU and 20 HU), soft tissues like liver (30 HU to 60 HU), iodinated contrast (100 HU to 500 HU), bones and other dense materials (above 300 HU). Filtering the CT scan images by selecting, for example, voxels with intensities between 30 HU and 60 HU can allow for identifying voxels associated with soft tissues, in particular the liver, thus improving the coregistration of the liver within CT scan images.

The method can have one or more of the following features.

The step of receiving at least two CT scan images comprising the liver can comprise receiving said CT scan images from a user (e.g. through a user interface), from a computer, from a transmitting device, from a data store. The step of receiving at least two CT scan images comprising the liver can comprise receiving said CT scan images previously obtained from at least two CT scans performed on the subject. For example, such CT scans can comprise arterial-phase CT scan, venous-phase CT scan, non-contrast-phase CT scan. The step of receiving at least two CT scan images comprising the liver can comprise receiving said CT scan images previously obtained from at least two CT scans performed on the subject with a time delay between the CT scans. For example, a pre-contrast-phase CT scan can be performed first, followed by an arterial-phase CT scan few seconds after contrast-injection, followed by a venous-phase CT scan few seconds after the arterial-phase CT scan.

The step of receiving at least two CT scan images comprising the liver can comprise receiving at least two CT scan images comprising the whole liver. The step of receiving at least two CT scan images comprising the liver can comprise receiving at least two CT scan images comprising a fraction of the liver. The step of receiving at least two CT scan images comprising the liver can comprise receiving at least one CT scan image comprising the whole liver and at least one CT scan image comprising a fraction of the liver.

The step of receiving at least two CT scan images comprising the liver can comprise receiving annotations associated with the received CT scan images. In some embodiments, the annotations can be received at the same time as the received CT scan images. In some other embodiments, the annotations can be received at some other time with respect to the received CT scan images.

In some embodiments, the annotations can be received in the form of a written text, a mask or an overlay on the image, as tabular data, as probability maps or in any other suitable way.

The step of obtaining a reference liver mask for the selected reference CT scan image can comprise executing one or more image analysis algorithms, for example a Convolutional Neural Network (CNN), a mask CNN, a mask R-CNN, a transformer-based algorithm or an attention-based algorithm. The reference liver mask can be a 2D mask. The reference liver mask can be a 3D mask. The step of obtaining a reference liver mask for the selected reference CT scan image can comprise obtaining a slice reference liver mask for each slice of the selected reference CT scan image and merging the obtained slice reference liver masks to obtain a reference liver mask.

For example, obtaining a slice reference liver mask for each slice of the selected reference CT scan image can comprise executing one or more image analysis algorithms on each slice of the selected reference CT scan image. For example, merging the obtained slice reference liver masks to obtain a reference liver mask can comprise overlapping the slice reference liver masks. The slice reference liver masks can be 2D masks.

Moreover, the present invention is directed to the surprising discovery that by training one or more machine-learning models with a training dataset processed as hereinbefore described it is possible to obtain trained machine-learning models able to detect and/or monitor HCC. For example, by training the one or more machine-learning models on pairs of CT scan images (e.g. CT scan images from an arterial-phase CT scan and a venous-phase CT scan) comprising a liver from a plurality of subjects, it is possible for the one or more models to learn common HCC-related lesion patterns, for example in terms of locations and/or sizes of the lesions, recurrent combinations of features characterizing said lesions and/or the liver, associations between said features and HCC evolution, probabilities of the presence of a lesion in a given location. Thus, according to a second aspect, there is provided a method of obtaining one or more trained machine-learning models for detecting and/or predicting HCC in CT scan images comprising a liver, the method comprising the steps of: receiving a training dataset, the training dataset comprising a plurality of CT scan images from a plurality of subjects, the plurality of CT scan images comprising at least two CT scan images from each subject, and wherein the at least two CT scan images from each subject comprise the liver of the subject, and wherein the at least two CT scan images from each subject are processed according to the first aspect; training the one or more machine-learning models using the received training dataset to obtain one or more trained machine-learning models, wherein training the one or more machine-learning models comprises, for each processed at least two CT scan images from each subject: segmenting objects of interest within the liver; and/or calculating at least one probability map associated with the liver of the subject. The method can further comprise outputting the one or more trained machine-learning models. The training dataset can further comprise annotations associated with the CT scan images therein comprised.

The step of training the one or more machine-learning models using the received training dataset can comprise training a single machine-learning model using the training dataset, training a single machine-learning model using one or more of a plurality of subsets of the training dataset, training multiple machine-learning models using the training dataset, training multiple machine-learning models using one or more of a plurality of subsets of the training dataset. The step of training a single machine-learning model using a plurality of subsets of the training dataset can comprise training the single machine-learning model in series using a plurality of subsets of the training dataset. The step of training a single machine-learning model using a plurality of subsets of the training dataset can comprise training the single machine-learning model in parallel using a plurality of subsets of the training dataset. The step of training multiple machine-learning models using one of a plurality of subsets of the training dataset can comprise training the multiple machine-learning models in series using one of a plurality of subsets of the training dataset. The step of training multiple machine-learning models using one of a plurality of subsets of the training dataset can comprise training the multiple machine-learning models in parallel using one of a plurality of subsets of the training dataset. The step of training multiple machine-learning models using a plurality of subsets of the training dataset can comprise training the multiple machine-learning models in series using a plurality of subsets of the training dataset. The step of training multiple machine-learning models using a plurality of subsets of the training dataset can comprise training the multiple machine-learning models in parallel using a plurality of subsets of the training dataset. The step of training the one or more machine-learning models can further comprise evaluating the training performance of the one or more trained machine-learning models. The one or more machine-learning models can be nn-UNets models.

The step of receiving a training dataset, the training dataset comprising a plurality of CT scan images from a plurality of subjects, can comprise receiving annotations associated with the received CT scan images. In such embodiments, the plurality of subsets of the training dataset can be obtained using the receiving annotations. For example, subsets of the training dataset can be obtained using the total volume of whole tumors relative to the volume of the liver, the number of whole tumors, the total volume of portal vein thrombosis, the total volume of cysts, or any combination thereof, as present in the received annotations.

The step of segmenting objects of interest within the liver can comprise obtaining outline and volume of the objects of interest. The step of segmenting object of interest within the liver can comprise executing one or more segmentation algorithms, for example one or more of a CNN, a mask CNN, a mask R-CNN, a nn-UNets model. The step of segmenting objects of interest within the liver can comprise evaluating the segmentation performance via segmentation metrics. For example, segmentation metrics can comprise DICE coefficients, Intersection-over-Union (IoU).

The step of segmenting objects of interest within the liver can further comprise detecting the segmented objects of interest. The step of detecting the segmented objects of interest can comprise extracting features of the segmented objects of interest. The step of detecting the segmented objects of interest can comprise obtaining locations and number of the objects of interest. The step of detecting the segmented objects of interest can comprise evaluating the detection performance via detection metrics. For example, detection metrics can comprise metrics estimating true positives, false positives, true negatives, false negatives.

The step of calculating at least one probability map associated with the liver of the subject can comprise calculating a probability value associated with each voxel within the liver. The probability value can comprise the probability of the presence of a lesion. The probability value can comprise the probability of a lesion occurring. The step of calculating at least one probability map associated with the liver of the subject can comprise calculating a probability value associated with each voxel of the at least one segmented object of interest. The step of calculating at least one probability map associated with the liver of the subject can comprise calculating a probability value associated with each voxel of each segmented object of interest.

The method can further comprise normalizing the processed CT scan images, wherein normalizing can comprise scaling the CT scan images using CT scan image intensity, performing a z-score normalization, or any combination thereof. Scaling the CT scan images using CT scan image intensity can comprise dividing all the voxel intensities in the CT scan images by a predetermined number. A suitable predetermined number can be for example 100. Performing a z-score normalization can comprise applying the following operations to all the voxel intensities in the CT scan images: subtracting the mean and dividing the standard deviation of all the voxel intensities in the liver mask.

According to a third aspect, there is provided a method of using one or more machine-learning models, trained according to the second aspect, to detect and/or predict HCC in CT scan images comprising a liver of a subject, the method comprising the steps of: receiving at least two CT scan images comprising the liver of the subject, processed according to the first aspect; segmenting objects of interest within the liver; and/or calculating at least one probability map associated with the liver of the subject. The objects of interest within the liver can comprise active hepatocellular carcinoma (HCC) tumor lesions, whole tumor lesions, necrosis, cysts, chemoembolizations, or any combination thereof. The step of calculating at least one probability map associated with the liver of the subject can comprise calculating a probability value associated with each voxel within the liver. The probability value can comprise the probability of the presence of a lesion, for example the presence of a whole HCC tumor lesion. The probability value can comprise the probability of a lesion occurring, for example the probability of an HCC tumor lesion occurring.

The step of calculating at least one probability map associated with the liver of the subject can comprise calculating a probability value associated with each voxel of the at least one segmented object of interest. The step of calculating at least one probability map associated with the liver of the subject can comprise calculating a probability value associated with each voxel of each segmented object of interest.

According to a fourth aspect, there is provided a method of diagnosing or monitoring HCC in a subject, the method comprising detecting and/or predicting HCC using the method of any embodiment of the preceding aspects. Diagnosing or monitoring HCC can comprise determining whether the subject has HCC tumor lesions. Diagnosing or monitoring HCC can comprise determining whether the subject has active HCC tumor lesions. Diagnosing or monitoring HCC can comprise determining whether the subject is likely to develop HCC. Diagnosing or monitoring HCC can comprise evaluating the risk of contracting HCC. Diagnosing or monitoring HCC can comprise determining the degree of HCC progression. Diagnosing or monitoring HCC can further comprise determining the eligibility of the subject to a predetermined treatment. Diagnosing or monitoring HCC can comprise assessing the response of the subject to a predetermined treatment. Diagnosing or monitoring HCC can comprise classifying the subject based on the presence of HCC. Diagnosing or monitoring HCC can comprise extracting features of the HCC.

Extracting features of the HCC can further comprise classifying the subject based on said extracted features. Extracting features of the HCC can further comprise comparing said features to one or more reference values. The one or more reference values can comprise an expected value of said features associated with a healthy population (e.g. mean value previously determined for a healthy population). The one or more reference values can comprise an expected value of said features associated with a diseased population (e.g. mean value previously determined for a diseased population). The one or more reference values can comprise a value of said features previously obtained for the same subject.

According to a fourth aspect, there is provided a method of treating a subject for HCC, the method comprising: determining whether the subject has HCC using the method of any embodiment of the third aspect; and administering a therapeutically effective amount of a therapy for the treatment of HCC to the subject who has been determined as having HCC.

According to a further aspect, there is provided a system of a processor, and a computer readable medium comprising instructions that, when executed by the processor, cause the processor to perform the computer-implemented steps of the method of any preceding aspect. The system can further comprise means for acquiring CT scan images. According to a further aspect, there is provided a non-transitory computer readable medium or media comprising instructions that, when executed by at least one processor, cause the at least one processor to perform the method of any embodiment of any aspect described herein. According to a further aspect, there is provided a computer program comprising code which, when the code is executed on a computer, causes the computer to perform the method of any embodiment of any aspect described herein.

### BRIEF DESCRIPTION OF THE FIGURES

FIG. 1 illustrates an embodiment of a system that can be used to implement one or more aspects described herein.

FIG. 2 is a flow diagram showing, in schematic form, a method of processing CT scan images comprising a liver of a subject, according to the invention.

FIG. 3 is a flow diagram showing, in schematic form, a method of obtaining one or more trained machine-learning models for analyzing CT scan images comprising a liver of a subject, according to the invention.

FIG. 4 is a flow diagram showing, in schematic form, a method of obtaining in series two trained machine-learning models for analyzing CT scan images comprising a liver of a subject, according to the invention.

FIG. 5 is a flow diagram showing, in schematic form, a method of obtaining in parallel two trained machine-learning models for analyzing CT scan images comprising a liver of a subject, according to the invention.

FIG. 6 is a flow diagram showing, in schematic form, a method of using a trained machine-learning model to identify objects of interest in CT scan images comprising a liver of a subject, according to the invention.

FIG. 7 shows a visual example of ground-truth refinement consisting of merging liver mask and ground-truth lesion masks, according to the invention.

FIG. 8 shows a visual example of ground-truth refinement consisting of removing small lesions from the ground-truth lesion masks, according to the invention.

FIG. 9 shows an example of the diagram of an end-to-end data processing pipeline, according to the invention.

FIG. 10 shows an example of probability thresholds selection in the binarization phase with multiple nn-UNets models, according to the invention.

FIG. 11 shows a visual example of ensembling phase with multiple nn-UNets models, according to the invention.

FIGS. 12-15 show the results of an application of an end-to-end data processing pipeline, according to the invention.

### DETAILED DESCRIPTION

Unless defined otherwise, technical and scientific terms used herein have the same meaning as commonly understood by one of ordinary skill in the art to which this invention belongs. All references cited herein, including patent applications and publications, are incorporated by reference in their entirety.

For purposes of interpreting this specification, the following definitions will apply and whenever appropriate, terms used in the singular will also include the plural and viceversa. It is to be understood that the terminology used herein is for the purpose of describing particular embodiments only, and is not intended to be limiting. Unless otherwise stated, the following terms used in the specification and claims have the meanings given below.

As used herein “data” and “images” are used interchangeably unless otherwise specified.

As used here “CT scan images comprising a liver” and “CT scan images” are used interchangeably.

As used herein “CT scan images” are used with the meaning of images obtained from a CT scan. Unless specified otherwise, CT scan images are intended as 3D images, reconstructed from the 2D slices obtained from each detector in the CT scanner used (common available CT slice counts include at present 16, 32, 40, 64, and 128 slices). As used herein, a 3D CT scan image produced with a 32-slice CT scanner comprises at least 32 2D images.

As used herein “voxels” are the volumetric units in 3D images, and “pixels” are the spatial units in 2D images. As used herein “resolution” of a 3D image, e.g. a CT scan image, is directly proportional to the number of voxels and inversely proportional to the size of voxels.

As used herein “masks” are 3D contours of objects in a 3D image, e.g. a CT scan image. As used herein “dilating” a mask assumes the technical meaning of making the mask thicker in all directions. As used herein “cropping” means keeping the part of the CT scan image contained 345 within a boundary and rejecting the part of the CT scan image outside said boundary.

As used herein “coregistration” relates to the technical meaning of correlation of anatomical and/or metabolic data from medical images. Equivalently, “coregistration” is intended as the geometric alignment of the images so that corresponding pixels (in 2D) or voxels (in 3D) representing the same objects in the different images can be integrated or fused. Rigid coregistration relates to correlation of anatomical data between rigid objects, i.e. objects not deformed, e.g. the same non-deformed liver in two images. Deformable coregistration means correlation of anatomical data between non-rigid objects, e.g. an original version of the liver in an image and a deformed version of the same liver in another image. An original version of the liver in an image and its deformed version in another image can be the result of different breathing phases of the subject at the time of acquiring the two images. As used herein “coregistering” corresponds to performing a coregistration, with the meaning of coregistration as hereinbefore defined.

As used herein “phases” of CT scans are types of scans acquired at different times after contrast injection, i.e. regulated by a standard protocol of time intervals between intravenous contrast administration and image acquisition. Each phase allows to visualize the dynamics of contrast enhancement in different organs and tissues, depending on the purpose of the investigation. As used herein, non-contrast or non-enhanced CT scans are comprised in CT scans. CT scans in arterial phase (approximately 20-25 seconds post injection) best enhance all structures that get their blood supply from the arteries. CT scans in venous phase (approximately 60-70 seconds post injection), also known as portal or portal/venous phase, best enhance the portal vein.

As used herein “CT scan images comprising a liver” are intended as CT scan images, for example images from CT scans of the abdomen, comprising a whole liver or a portion thereof.

As used herein “active” in the context of tumor lesions addresses lesions of active tumors, i.e. alive and/or progressing, as opposed to necrosis, i.e. dead cells or portions of organs. The term “chemoembolization” assumes the meaning known to the person skilled in the art of a region where the blood supply to a tumor is blocked, for example via anticancer drugs. In daily practice, doctors can annotate chemoembolizations as part of active tumor lesions. As used herein “whole tumor lesions” comprise active tumor lesions comprising chemoembolizations.

As used herein machine-learning “algorithms” and “models” are used interchangeably unless otherwise specified.

As used herein and unless otherwise specified “training dataset” is a dataset, used for training models, comprising a plurality of CT scan images from a plurality of subjects. The training dataset comprises, from each subject, at least two CT scan images from different CT scans performed on the same subject, e.g. scans in different phases.

As used herein “training” a machine-learning model assumes the standard meaning known to the person skilled in the art, and comprises finding the best combination of model parameters, e.g. weights and bias (depending on the architecture of the model), to minimize a loss function over training data.

As used herein “segmenting” objects of interest assumes the technical meaning of identifying contours (e.g. 2D bounding boxes, 3D bounding boxes) around the objects of interest. The “segmentation metrics” measure the overlap between such contours. As used herein “detecting” segmented objects of interest assumes the technical meaning of finding separate instances of the segmented objects, and/or characterizing such separate instances, e.g. obtaining their location (coordinates, relative distances), their number.

As used herein “probability map”, also known as heat map, is intended as a distribution of 390 probability values per voxel (when applied to 3D images) or per pixel (when applied to 2D images).

As used herein “individual”, “subject”, “patient” are used interchangeably to indicate a mammal. Mammals include, but are not limited to, domesticated animals (e.g. cows, sheep, cats, dogs and horses), primates (e.g. humans and non-human primates such as monkeys), rabbits, and rodents (e.g. mice and rats). In certain embodiments, the individual, subject, patient is a human, in particular an adult or pediatric individual, subject, patient. The subject can be a healthy subject or a subject having been diagnosed having a disease or disorder or being likely to have a disease or disorder.

The systems and method described herein can be implemented in a computer system, in addition to the structural components and user interactions described. As used herein, the term “computer system” includes the hardware, software and data storage devices for embodying a system and carrying out a method according to the described embodiments. For example, a computer system can comprise one or more central processing units (CPU) and/or graphics processing units (GPU), input means, output means and data storage, which can be embodied as one or more connected computing devices. Preferably the computer system has a display or comprises a computing device that has a display to provide a visual output display. The data storage can comprise RAM, disk drives, solid-state disks or other computer readable media. The computer system can comprise a plurality of computing devices connected by a network and able to communicate with each other over that network. It is explicitly envisaged that computer system can consist of or comprise a cloud computer.

The methods described herein are computer implemented unless context indicates otherwise. Indeed, the features of the data processed and used to train machine-learning models are such that the methods described herein are far beyond the capability of the human brain and can not be performed as a mental act. The methods described herein can be provided as computer programs or as computer program products or computer readable media carrying a computer program which is arranges, when run on a computer, to perform the method(s) described herein. As used herein, the term “computer readable media” includes, without limitation, any non-transitory medium or media which can be read and accessed directly by a computer or a computer system. The media can include, but are not limited to, magnetic storage media such as floppy discs, hard disc storage media, magnetic tape; optical storage media such as optical discs or CD-ROMs; electrical storage media such as memory, including RAM, ROM and flash memory; hybrids and combinations of the above such as magnetic/optical storage media.

### Systems

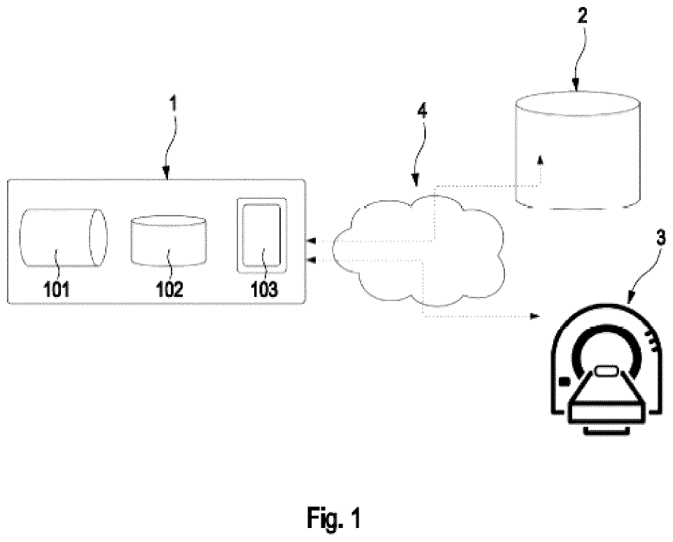

FIG. 1 illustrates an embodiment of a system that can be used to implement one or more aspects described herein. With reference to FIG. 1, the system comprises a computing device 1, which comprises a processor 101 and a computer readable memory 102. In the embodiment shown, the computing device 1 also comprises a user interface 103, which is illustrated as a screen but can include any other means of conveying information to a user such as e.g. through audible or visual signals. The computing device 1 is communicably connected, such as e.g. through a network, to CT scan images acquisition means, such as a CT scanner, and/or to one or more databases 2 storing CT scan images. The one or more databases 2 can further store one or more of: control data, parameters (such as e.g. thresholds derived from control data, parameters used for normalization, etc.), clinical and/or patient related information, etc. The computing device can be a smartphone, tablet, personal computer or other computing device.

The computing device can be configured to implement a method of processing CT scan images comprising a liver of a subject, as described herein. In alternative embodiments, the computing device 1 is configured to communicate with a remote computing device (not shown), which is itself configured to implement a method of processing CT scan images comprising a liver of a subject, as described herein. In such cases, the remote computing device can also be configured to send the result of the method of processing CT scan images comprising a liver of a subject. Communication between the computing device 1 and the remote computing device can be through a wired or wireless connection, and can occur over a local or public network 4 such as e.g. over the public internet. The CT scan images acquisition means 3 can be in wired connection with the computing device 1, or can be able to communicate through a wireless connection, such as e.g. through WiFi and/or over the public internet, as illustrated. The connection between the computing device 1 and the CT scan images acquisition means 3 can be direct or indirect (such as e.g. through a remote computer). The CT scan images acquisition means 3 are configured to CT scan images comprising a liver of a subject. In some embodiments, the CT scan images can have been subject to one or more preprocessing steps (eg cropping, resizing, normalizing, etc) prior to performing the methods described herein.

### Methods

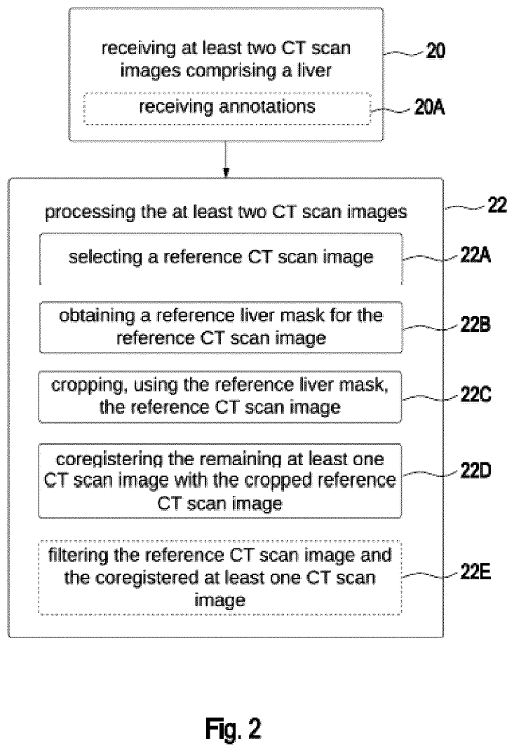

FIG. 2 is a flow diagram showing, in schematic form, a method of processing CT scan images comprising a liver of a subject, according to the invention. With reference to FIG. 2, at step 20 at least two CT scan images comprising a liver are received. This can comprise optionally receiving annotations (20A), for example ground-truth annotations indicating the presence of a lesion in the liver. At step 22, the at least two CT scan images are processed. Processing can comprise several steps. At step 22A, a reference CT scan image is selected from the received at least two CT scan images. In an embodiment, the reference CT scan image can be selected based on the CT scan images resolution. For example, the reference CT scan image can be selected as the CT scan image with highest resolution. The resolution of a CT scan image can be computed using the number of voxels or the voxel size: the resolution is directly proportional to the number of voxels and indirectly proportional to the voxel size. In another embodiment, the reference CT scan image can be selected based on the portion of the liver contained in the CT scan images. For example, the reference CT scan image can be selected as the CT scan image with the highest portion of the liver among the received CT scan images. In an embodiment, the highest portion of the liver can comprise the whole liver. In another embodiment, the reference CT scan image can be the CT scan image obtained in a certain contrast phase among all the received ones. For example, the reference CT scan image can be the arterial phase CT scan image. For example, the reference CT scan image can be the venous phase CT scan image. At step 22B, a reference liver mask is obtained for the reference CT scan image. This step can comprise executing one or more image analysis algorithms, for example a mask CNN. The reference liver mask can be overlaid to the reference CT scan image. The reference CT scan image can comprise the reference liver mask. At step 22C, the reference CT scan image can be cropped using the reference liver mask. For example, the reference CT scan image can be cropped along the reference liver mask contours to be limited to the portion of the CT scan image contained within the reference liver mask. Alternatively, the reference CT scan image can be cropped to comprise the reference liver mask and the portion of the CT scan image contained within the reference liver, as well as some voxels outside the reference liver mask contours. At step 22D, the remaining at least one CT scan image is coregistered with the cropped reference scan image. For example, the venous CT scan image can be coregistered with the arterial CT scan image cropped along the contours of the reference liver mask. Alternatively, the arterial CT scan image can be coregistered with the venous CT scan image cropped along the contours of the reference liver mask. In an embodiment, each of the remaining at least one CT scan image is coregistered in series with the cropped reference CT scan image. In another embodiment, each of the remaining at least one CT scan image is coregistered in parallel with the cropped reference CT scan image. The coregistration can be performed by executing an algorithm that overlays the reference liver mask on the CT scan image to be coregistered with the reference CT scan image. The coregistration can be performed by executing one or more algorithms that identify similar patterns between the reference CT scan image and the CT scan image to be coregistered. The coregistration can be performed by executing one or more algorithms that identify similar patterns between the reference liver mask and the CT scan image to be coregistered. The coregistration can be performed by executing one or more algorithms that apply a deformation to the reference liver mask and identify similar patterns between the deformed reference liver mask and the CT scan image to be coregistered. The coregistration can be performed by executing one or more algorithms that apply a deformation to the reference CT scan image and identify similar patterns between the deformed reference CT scan image and the CT scan image to be coregistered. The coregistation can be performed by executing one or more algorithms that apply a deformation to the CT scan image to be coregistered and identify similar patterns between the deformed CT scan image to be coregistered and the reference CT scan image. At optional step 22E, the reference CT scan image and the coregistered at least one CT scan image can be filtered. For example, the CT scan images can be filtered using the voxel intensities.

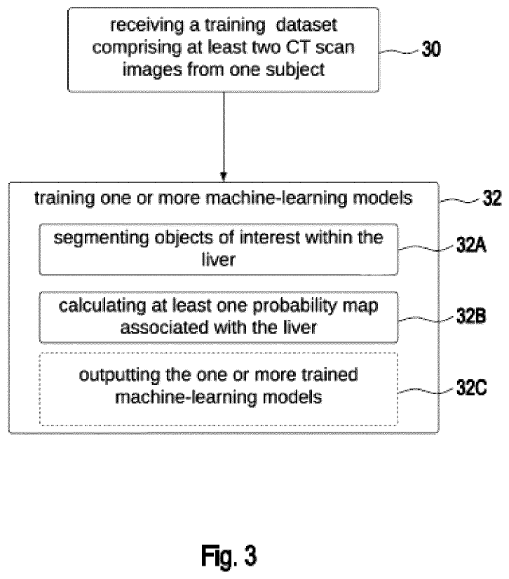

FIG. 3 is a flow diagram showing, in schematic form, a method of obtaining one or more trained machine-learning models for analyzing CT scan images comprising a liver of a subject, according to the invention. With reference to FIG. 3, at step 30 a training dataset is received, the dataset comprising at least two CT scan images from a subject. The training dataset can optionally comprise annotations associated with the CT scan images comprised in the dataset. For example, annotations can comprise indications of the presence of a lesion in an organ. The training dataset can comprise images comprising the liver of the subject. In such embodiments, annotations can comprise indications of the presence of a lesion in the liver. The at least two CT scan images comprised in the training dataset can be pre-processed according to embodiments of the present invention as hereinbefore described. At step 32, one or more machine-learning models are trained. The one or more machine-learning models can be models with the same architecture. The one or more machine-learning models can be models with different architecture. Training can comprise several steps. At step 32A, objects of interest within the liver can be segmented. For example, lesions within the liver can be segmented. For example, HCC lesions can be segmented. For example, HCC lesions comprising chemoembolizations can be segmented. This step can be performed by executing one or more algorithms, for example nn-UNets algorithms. At step 32B, at least one probability map associated with the liver can be calculated. For example, a 3D probability map can be calculated with probabilities of HCC lesion occurrence associated with each voxel of the CT scan images in the dataset. For example, the probabilities per voxel can be calculated based on the intensities of each voxel of the CT scan images. In an embodiment, probabilities per voxel can be calculated based on the intensities of the voxels of the set of coregistered CT scan images. At optional step 32C, the one or more trained machine-learning models is outputted.

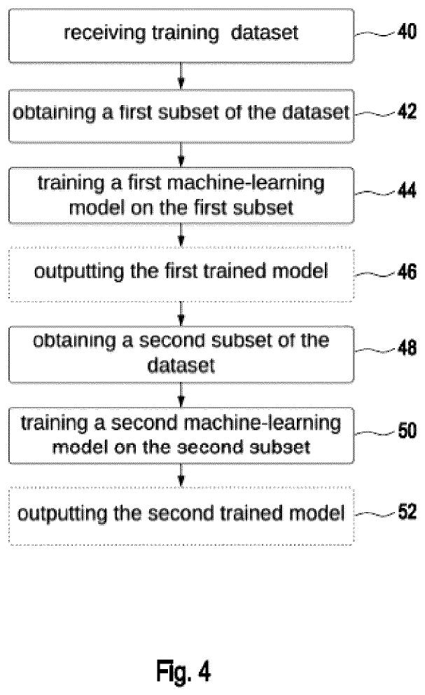

FIG. 4 is a flow diagram showing, in schematic form, a method of obtaining in series two trained machine-learning models for analyzing CT scan images comprising a liver of a subject, according to the invention. With reference to FIG. 4, at step 40 a training dataset is received, the training dataset as hereinbefore described. At step 42, a first subset of the training dataset is obtained. For example, from the pre-processed CT scan images comprised in the training dataset, a subset is obtained of all CT scan images comprising a portion of the liver above a certain threshold. For example, from the pre-processed CT scan images comprised in the training dataset, a subset is obtained of all CT scan images with a resolution above a certain threshold. For example, from the pre-processed CT scan images comprised in the training dataset, a subset is obtained of all CT scan images with annotations associated to them indicating the presence of a lesion. At step 44, a first machine-learning model is trained on the first subset of the dataset. At optional step 46, the first trained model is outputted. At step 48, a second subset of the training dataset is obtained.

The second subset can be the same as the first subset. The second subset can be a subset of the first subset. The second subset can contain the first subset. The second subset and the first subset can be disjoint. At step 50, a second machine-learning model is trained on the second subset of the dataset. The second machine-learning model can be the same as the first machine-learning model. The second machine-learning model can be different from the first machine-learning model. At optional step 52, the second trained model is outputted.

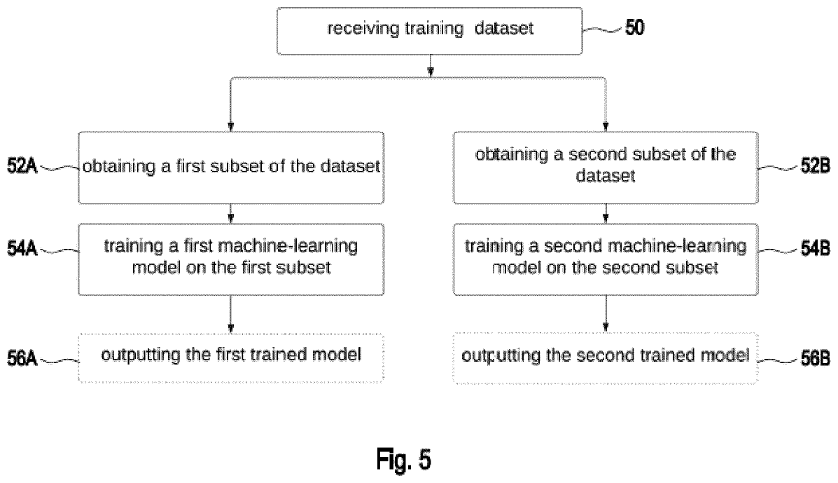

FIG. 5 is a flow diagram showing, in schematic form, a method of obtaining in parallel two trained machine-learning models for analyzing CT scan images comprising a liver of a subject, according to the invention. With reference to FIG. 5, at step 50 a training dataset is received, the training dataset as hereinbefore described. At step 52A, a first subset of the training dataset is obtained. For example, from the pre-processed CT scan images comprised in the training dataset, a subset is obtained of all CT scan images comprising a portion of the liver above a certain threshold. For example, from the pre-processed CT scan images comprised in the training dataset, a subset is obtained of all CT scan images with a resolution above a certain threshold. For example, from the pre-processed CT scan images comprised in the training dataset, a subset is obtained of all CT scan images with annotations associated to them indicating the presence of a lesion. At step 52B, a second subset of the training dataset is obtained. The second subset can be the same as the first subset. The second subset can be a subset of the first subset. The second subset can contain the first subset. The second subset and the first subset can be disjoint. At step 54A, a first machine-learning model is trained on the first subset of the dataset. At step 54B, a second machine-learning model is trained on the second subset of the dataset. The second machine-learning model can be the same as the first machine-learning model. The second machine-learning model can be different from the first machine-learning model. At optional step 56A, the first trained model is outputted. At optional step 56B, the second trained model is outputted.

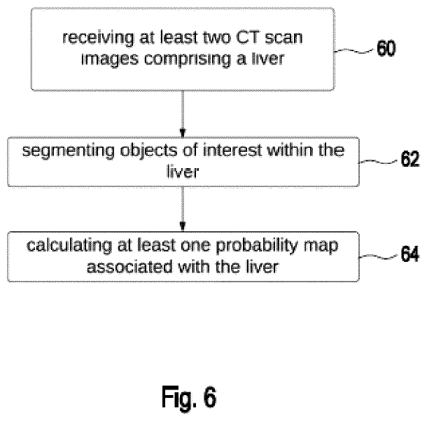

FIG. 6 is a flow diagram showing, in schematic form, a method of using a trained machine-learning model to identify objects of interest in CT scan images comprising a liver of a subject, according to the invention. With reference to FIG. 6, at step 60 at least two CT scan images comprising a liver are received, the images pre-processed as hereinbefore described. At step 62, objects of interest within the liver are segmented. For example, masks can be obtained for lesions within the liver. For example, masks can be obtained for HCC lesions. For example, masks can be obtained for HCC lesions with chemoembolizations. This step can comprise detecting the objects of interest within the liver. For example, lesions within the liver can be localized and counted. For example, HCC lesions can be localized and counted. For example, HCC lesions with chemoembolizations can be localized and counted. At step 64, at least one probability map associated with the liver is calculated. For example, a 3D probability map can be calculated with probabilities of HCC lesion occurrence associated with each voxel of the CT scan images in the dataset. For example, the probabilities per voxel can be calculated based on the intensities of each voxel of the CT scan images. In an embodiment, probabilities per voxel can be calculated based on the intensities of the voxels of the set of coregistered CT scan images.

### EXAMPLES

The examples below illustrate applications of the methods of the present invention, in particular in the context of HCC detection in CT scan images. Example 1 shows a training dataset preparation according to the invention. Example 2 shows results of the processing pipeline according to the invention applied to liver tumor segmentation.

### Example 1—Training Dataset Preparation

In this example, a benchmark patient dataset was selected based on a clinical trial involving patients with HCC (Finn et al, 2020). It included 184 patients, of which: 102 without cirrhosis, 82 with cirrhosis; 33 females, 151 males; 84 Asians, 78 Whites, 4 Afro-Americans, 18 unknown. The mean age was 66 years old, with standard deviation 10, minimum 34 and maximum 87. Table I shows the CT scan acquisition guidelines used in the clinical trial.

The dataset was annotated by a team of radiology specialists consisting of 5 juniors (3 years of experience on average) and 2 experts (20 years of experience on average). The latter were responsible for reviewing the annotations prepared by the former. Each training set annotation required acceptance from a single expert, each test set annotation was double-checked by both experts. The doctors received coregistered CT scan images, one arterial and one venous per patient, and contoured five classes of objects (ground-truth lesion masks): active HCC tumors, necrosis, portal vein thrombosis, cysts, other lesions. The doctors specified the confidence levels (1-4) for each class (along with one additional confidence value of overall segmentation) for every 595 annotation. If they identified voxels of a class and were confident about the output segmentation or if they were confident that a specific class was missing from the image, they marked it with confidence 4. The average value for all confidence values of experts was higher than 3.5. The doctors included chemoembolizations (HU>150) in annotations and contoured them as part of the active HCC tumor class. Since chemoembolizations were annotated consistently for all data, these were handled consistently in the post-processing phase of the study, depending on the segmented classes and response assessment criteria used.

Due to insufficient quality of coregistration, 4 patients were removed from the dataset. The scans from the remaining 180 patients were dividing into training set and test set. To ensure a relatively similar distribution of tumor characteristics between folds, patients were stratified according to the following parameters: total volume of whole tumors (HCC, necrosis) relative to the volume of the liver (Vₜ); total number of whole tumors (Nₜ), total volume of portal vein thrombosis (Vₚᵥ), total volume of cysts (V_{c}). For every of these stratification factors, each patient was assigned into one of two categories (small and big) based on the median value calculated for all lesions for all patients. Due to inconsistent characteristics of voxels and lack of representative samples, the “other lesions” class was not used in the stratification. Table II shows the patients stratified in 5 folds as a result of the stratification process described.

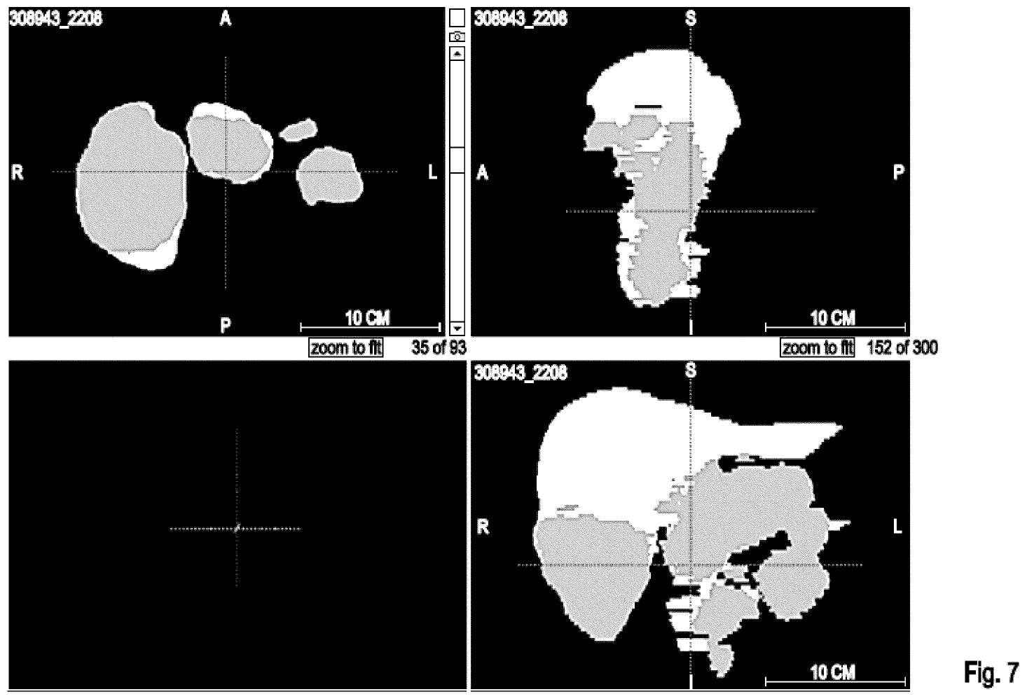

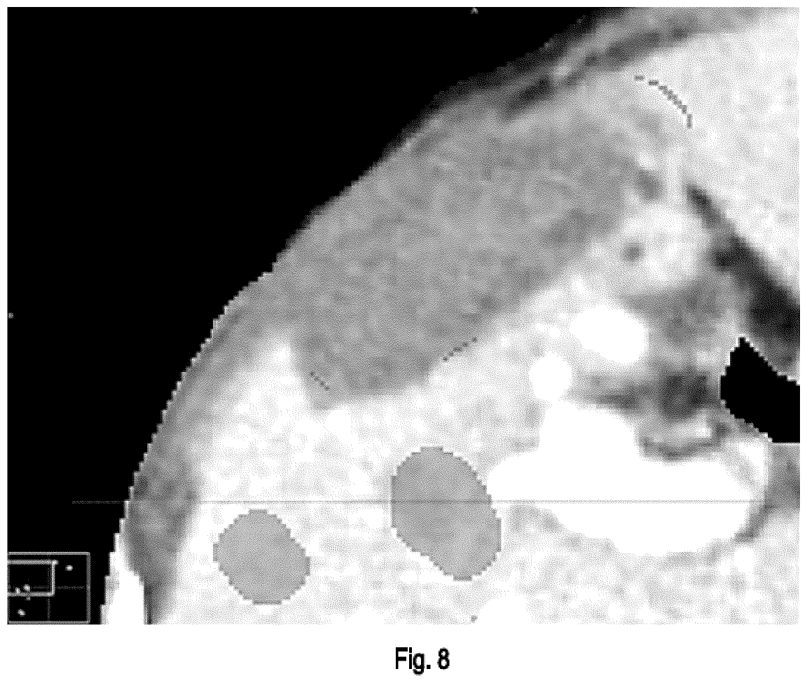

The following issues were observed concerning the ground-truth lesion masks obtained from the annotations:
Parts of the HCC ground-truth masks were outside the liver contours (especially for patients with advanced HCC or cirrhotic livers). As a solution, liver masks and HCC ground-truth masks were merged in a step of ground-truth refinement as shown in FIG. 7.
HCC ground-truth masks contained many extremely small tumors, as shown in FIG. 8. Such tumors were annotation mistakes or effect of semi-automatic thresholding approach used by some of the doctors. All tumors smaller than 20 mm³ were removed from the HCC ground-truth masks in a step of ground-truth refinement. The volume threshold of 20 mm³ was chosen empirically by analyzing the volume distributions and confirmed by visual inspection of a senior radiologist.

The training dataset was further preprocessed by cropping and masking the liver and by filtering voxel intensities in the range of (−100 HU, 150 HU). In this example, two approaches were used for CT images scan normalization: scaling the CT scan images using CT scan image intensity and performing a z-score normalization. In the scaling, all voxel intensities were divided by 100, so that the range of intensities was (−1 HU, 1.5 HU). In the z-score normalization, the mean of all the voxel intensities in the liver mask was subtracted from each voxel intensity and the subtracted intensities were divided by the standard deviation of all voxel intensities in the liver mask. In this way the liver voxels resulted in having a mean of 0 and a standard deviation of 1.

### Example 2—Processing Pipeline for Tumor Segmentation

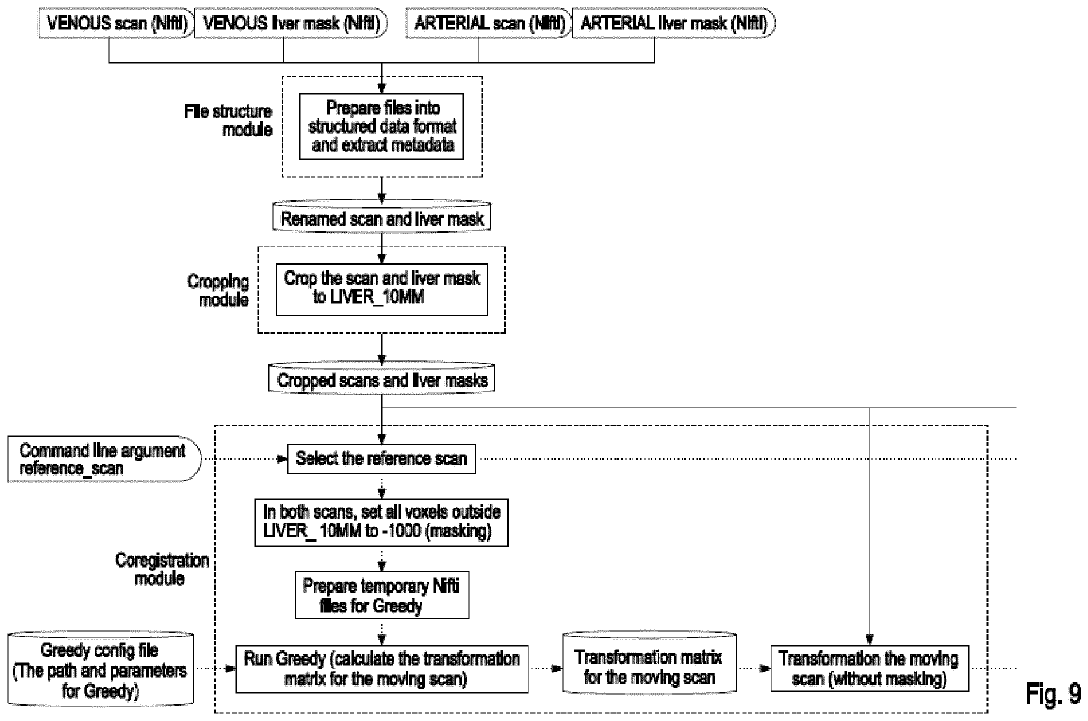

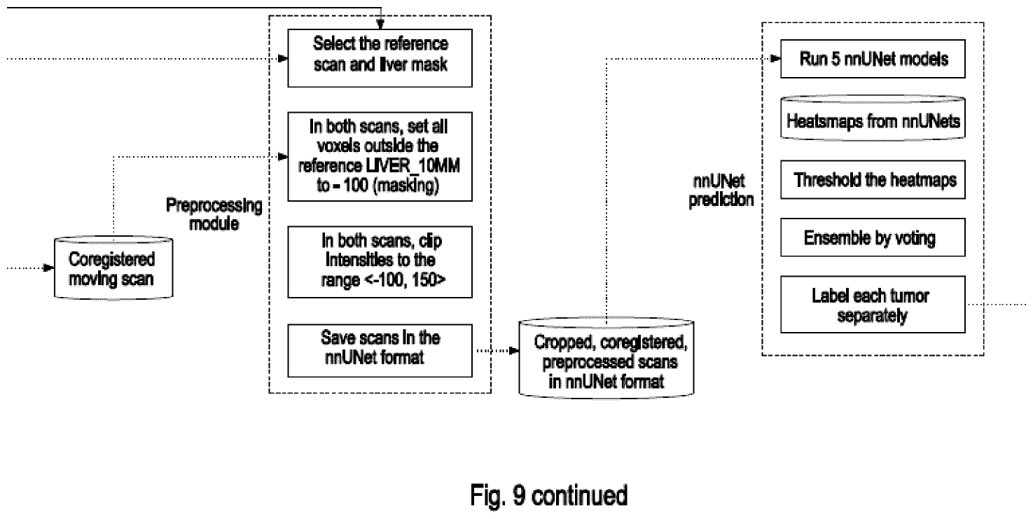

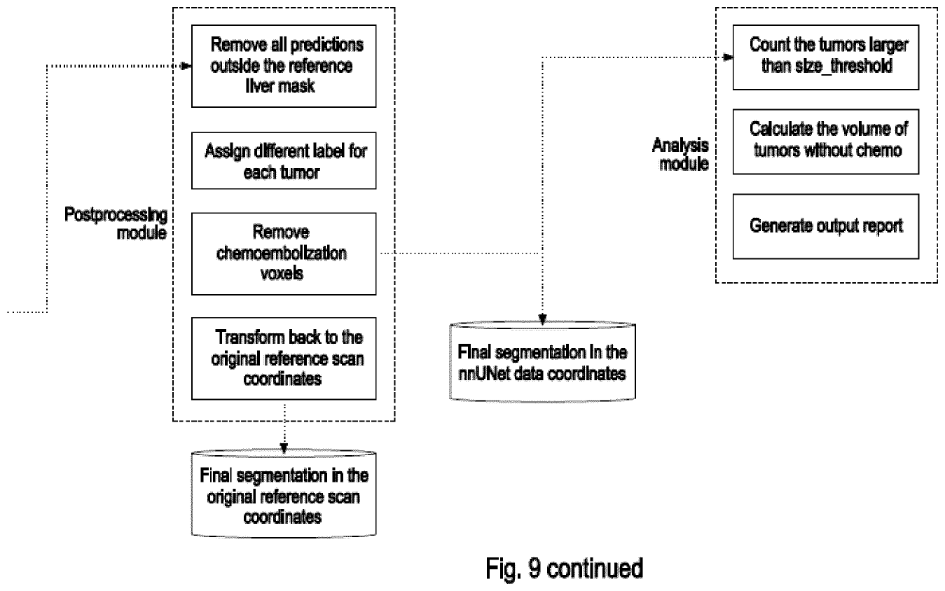

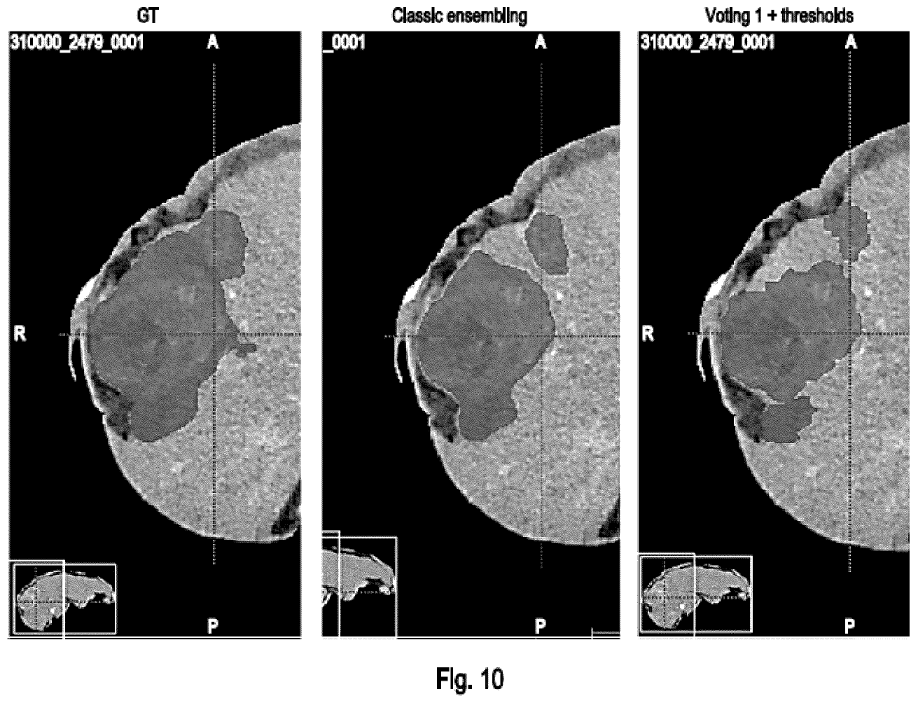

FIG. 9 shows the diagram of the data processing pipeline used in this example. It consisted of an end-to-end pipeline that accepted raw CT liver scans and performed automatic segmentation of liver tumors along with response assessment measurements. The pipeline was tested using a training dataset prepared as described in Example 1.

Several segmentation metrics were included in the pipeline. All segmentation metrics were calculated for the active part of the tumor not including chemoembolizations (i.e. not including voxels with intensities above 150 HU in both arterial and venous phase).

One example of segmentation metrics used is the DICE coefficient, which measures the overlap between the predicted segmentation and the ground truth and is expressed as twice the volume of overlap divided by the sum of volumes in both masks:

$$DICE = \frac{2 TP}{2 TP + FN + FP}$$

wherein TP corresponds to True Positives, FN corresponds to False Negatives and FP corresponds to False Positives.

Another example is the Intersection-over-Union (IoU), which also measures the overlap between the predicted segmentation and the ground truth and is expressed as the volume of overlap divided by the union of the predicted segmentation and the ground truth:

$$IoU = \frac{TP}{TP + FN + FP}$$

Both metrics were used to evaluate small and big tumors. However, usually small tumors had a marginal impact on the metrics.

Detection metrics reflect how many lesions were localized correctly regardless of their size. These metrics helped to assess the performance of models in terms of tumor identifications, especially for small lesions. All detection metrics were calculated for the whole tumor (including chemoembolizations). In order to calculate the metrics, the following steps were performed:
Extract all separate 3D “blobs” (representing lesions) from corresponding ground-truth lesion masks and prediction lesion masks.
Calculate the number of TP, FN, FP. True positives comprise cases in which a ground-truth blob overlaps with at least one prediction blob by some minimum IoU threshold. False negatives comprise cases in which there is no corresponding true positive for a ground-truth blob. False positive comprise cases in which for each prediction blob there is not corresponding true positive.
Use of TP, FN, FP to calculate Precision, Recall and Jaccard Index. The latter were calculated for a set of 20 loU thresholds within the range (0, 1) with a step of 0.1, i.e. IoU=0, 0.1, . . . , 0.9. The average values over the 20 loU thresholds were so computed:

$$< Precision >= {\sum }_{i = 1}^{20} \frac{{TP}_{i}}{{TP}_{i} + {FP}_{i}}$$

$$< Recall >= {\sum }_{i = 1}^{20} \frac{{TP}_{i}}{{TP}_{i} + {FN}_{i}}$$

$$< JaccardIndex >= {\sum }_{i = 1}^{20} \frac{{TP}_{i}}{{TP}_{i} + {FP}_{i} + {FN}_{i}}$$

These metrics range from 0 to 1. However it was extremely hard to achieve scores close to 1, because it was extremely hard to segment small tumors with IoU overlaps above 0.7.

The pipeline trained 5 separate nn-UNets models on 5 folds of the data as stratified in Example 1. The architecture and parameters (batch size, patch size, voxel size) of each model were automatically selected based on the training data. One of the parameters that were changed was the number of epochs, limited to 500. The loss function used was an average value of the DICE and categorical cross-entropy.

Loss-weighting was applied during the training. Instead of using the confidence of all annotators (scale 1-4 as in Example 1, weights 0.5, 0.75, 1.25, 1.5), the tumor annotation quality assessment done by the expert radiologists was used (same scale, same weights).

The raw output of nn-UNets models is a 3D array of probabilities, i.e. heat map, containing the probability values assigned to each voxel of the input CT scan images. If the nn-UNets models are trained on different classes of lesions (for example active HCC tumor lesions and whole tumor lesions), the outputs will be one heat map per class (for example one heat map with the probability values per voxel of containing active HCC tumor lesions and one heat map with the probability values per voxel of containing whole tumor lesions). Probability values in heat maps range from 0 to 1, corresponding to the confidence of the model on the prediction result.

The standard approach for a single model is to select voxels with probabilities values higher than a threshold, e.g. 0.5, as correctly-classified voxels, i.e. as voxels correctly identified as containing a lesion. In the present example, 5 nn-UNets models were trained. The two following steps were used to combine the outputs of the 5 models: 1) using different probability thresholds for each model to define correctly-classified voxels, also known as binarization phase; 2) using a voting process applied to each model and then merging the results of the voting process, also known as ensembling phase.

In the binarization phase, it was observed that using different probability thresholds for each model allowed for an improved performance of detection and segmentation. Validation data was used for this purpose, i.e. 20% of the training dataset. FIG. 10 shows an example of probability thresholds selection in the binarization phase with multiple nn-UNets, in particular 5 nn-UNets, according to the invention. First the maximum of the DICE (red curve) was obtained as well as all other DICE values not statistically significantly worse than the maximum in terms of one-sided signed-rank Wilcoxon test with p<0.05 (rectangular box on the red curve). Then, among these DICE values, the one with the largest <Jaccardindex> (circle on the blue curve) was chosen, in order to select more small blobs and fine-tune the detection metrics. In another embodiment, the order of these two steps can be swapped, i.e. first the maximum of the <Jaccardindex> can be found and thereafter the maximum of the DICE.

In the ensembling phase, the voting process consists in each model assigning, based on each probability threshold per model as selected in the binarization phase, a vote whether a voxel is associated with a lesion (1) or not (0). The voxel was ultimately considered as associated with a lesion, e.g. a tumor lesion, if it received at least N votes equal to 1, wherein N is a hyperparameter.

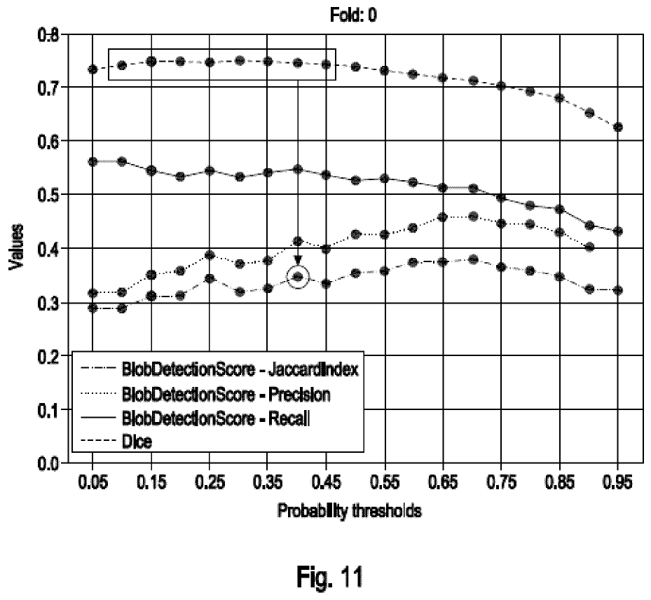

The lower N the higher the sensitivity of the model. Visual examples of the ensembling with multiple nn-UNets models, in particular 5 nn-UNets models, are presented in FIG. 11. On the left, a scan with ground truth segmentation is shown. In the middle, a scan with segmentation predicted by the ensemble of 5 models with classical ensembling is shown. Each model predicted a probability map (with values in range 0-1 for each voxel). These probabilities were averaged for all models, and then if the mean value per voxel was higher or equal than 0.5 such voxel was classified as lesion. For example, a positive prediction for a voxel was returned with the following results of the voting process: 0.2 (model 1), 0.7 (model 2), 0.8 (model 3), 0.9 (model 4), 0.9 (model 5); mean probability equal to 0.7>0.5. For example, a negative prediction for a voxel was returned with the following results of the voting process: 0.2 (model 1), 0.2 (model 2), 0.7 (model 3), 0.2 (model 4), 0.2 (model 5); mean probability equal to 0.3<0.5. On the right, a scan with segmentation predicted by the ensemble of 5 models with custom ensembling is shown. First, the optimized thresholds are used, then the voting process is performed. The optimal probability thresholds were selected as hereinbefore described. In the following example, first probability maps for all models were binarized based on the thresholds, then each model performed its vote whether the voxel is to be classified as lesion or not, with the following results: 0.2 (model 1)<0.5 (selected probability threshold for model 1), 0.7 (model 2)>0.6 (selected probability threshold for model 2), 0.8 (model 3)>0.6 (selected probability threshold for model 3), 0.9 (model 4)>0.7 (selected probability threshold for model 4), 0.9 (model 5)>0.7 (selected probability threshold for model 5). Thus in the previous example 4 models out of 5 voted the voxel to be classified as lesion. The ensembling with custom ensembling tends to classify more voxels as lesion compared to the classical ensembling.

### Results

Table III shows the results for three classes of models: Whole Tumors (WT), HCC, HCC+Necrosis (HCC+NEC).

Response assessment measurements were calculated and analyzed. Measurements for each patient were aggregated as many small blobs, both ground-truth and prediction, tended to be merged into bigger ones. By treating multiple separate blobs together, the impact of false negatives was mitigated.

Two cumulative metrics were analyzed: response assessment measurements (RECIST/mRECIST depending on the model) and lesion volumes (expressed in mm³).

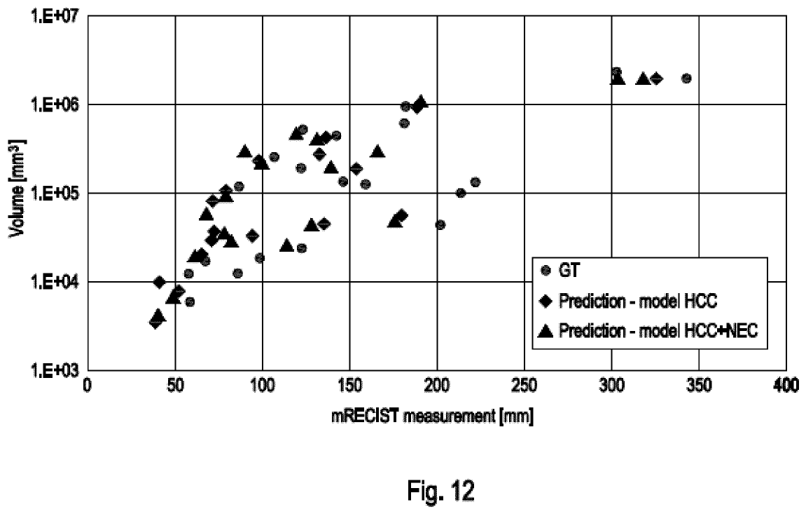

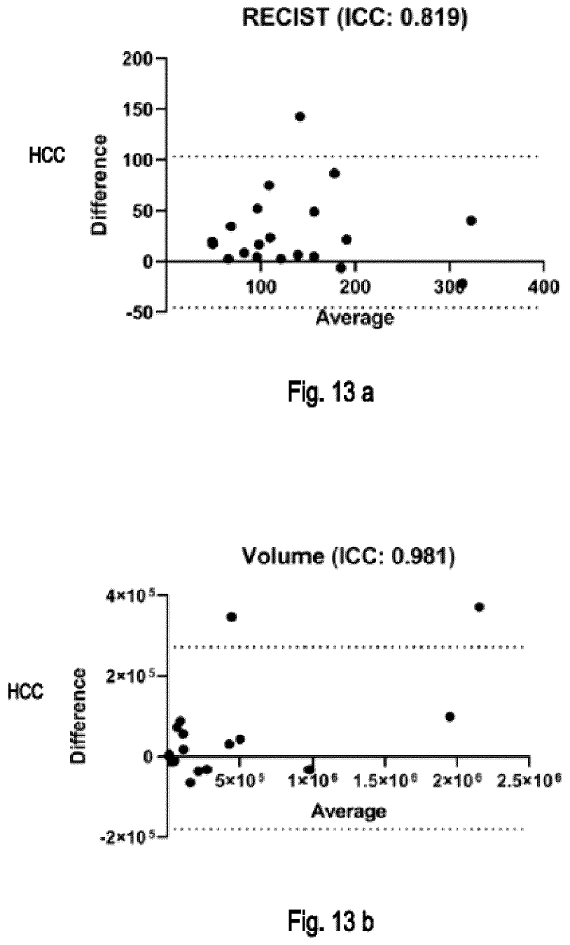

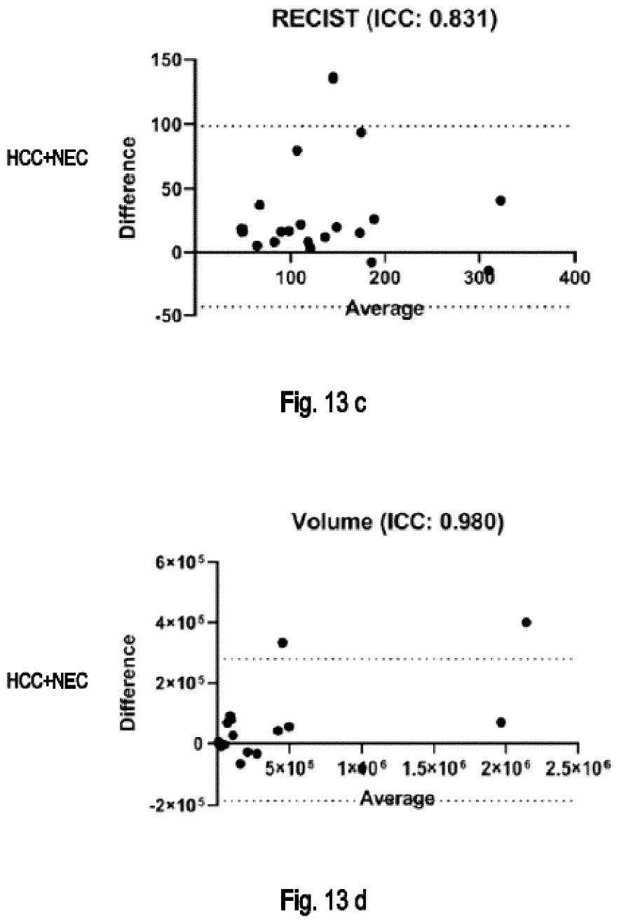

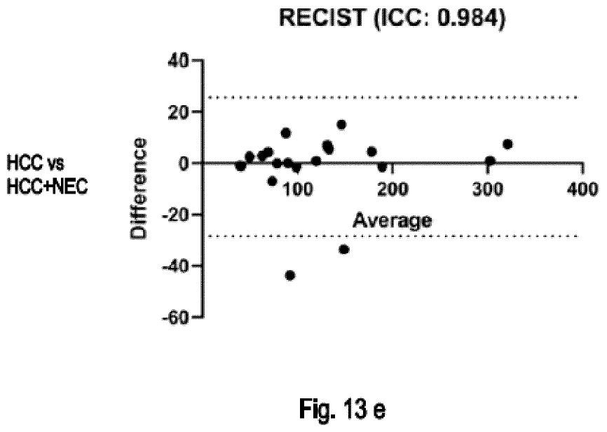

The response assessment based on mRECIST was performed for models segmenting the HCC tumor class, i.e. HCC and HCC+NEC. FIG. 12 shows the correlation of cumulative lesion volumes and mRECIST measurements aggregated for each patient, for ground-truth lesions and prediction lesions from the HCC model and the HCC+NEC model. The results of Pearson correlation coefficients for the HCC model and the HCC+NEC model are shown in Tables IV and V respectively. FIG. 13 shows the Bland-Altman plots for intraclass correlation coefficient (ICC) that describe how the plotted sets of measurements resemble each other. The correlation between the HCC and the HCC+NEC model is strong, with only few outliers present. Differences between the two models are negligible in terms of response assessment measurements (FIG. 13e)). The lowest values of Pearson correlation coefficients can be observed for mRECIST ground-truth. Its low correlation with all other metrics, especially volume ground-truth indicates that mRECIST may not be a reliable parameter for tracking lesion size and assessing tumor burden in 3D. All values on prediction masks are strongly correlated with volume ground-truth, and since the highest coefficients for volumetric measurements are equal to 0.98 (prediction vs ground-truth), the model proved to be robust and accurate in reflecting cancerous changes in the patient data. Most of the points in the Bland-Altman scatter plots are on the same sides of the 0 difference axis, indicating that the model is consistent in underestimating predicted lesions in comparison to ground-truth lesion masks.

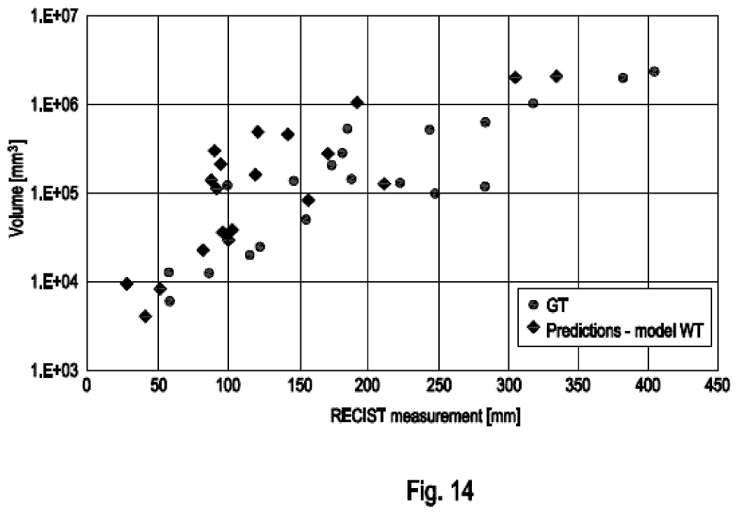

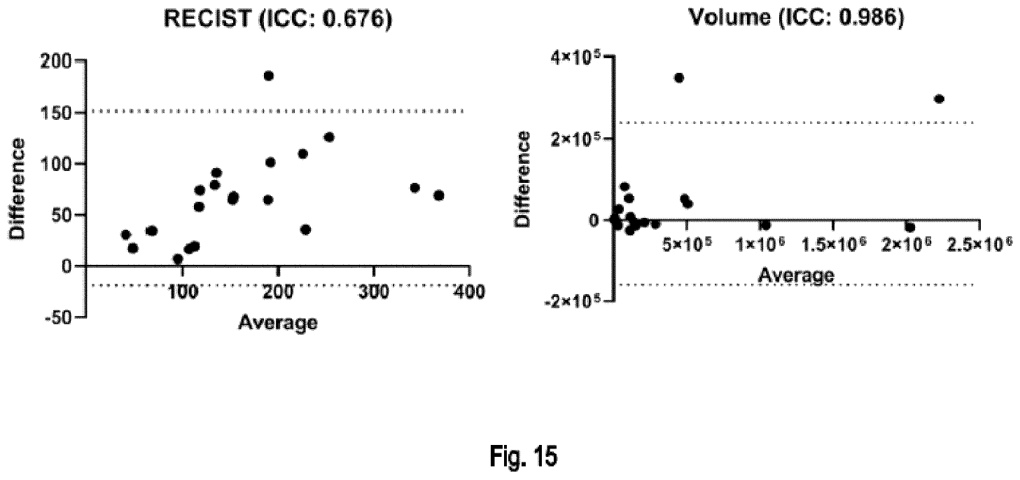

The response assessment based on RECIST was performed for the model segmenting the WT class. FIG. 14 shows the correlation of cumulative volumes and RECIST measurements aggregated for each patient. The results of Pearson correlation coefficients are shown in Table VI. FIG. 15 shows the Bland-Altman plots for intraclass correlation coefficient (ICC). The correlation between the two measurements is strong, with only few outliers present. The lowest values of Pearson correlation coefficients can be observed for RECIST ground-truth. Its low correlation with volume ground-truth indicates that RECIST may not be a reliable parameter for tracking lesion size and assessing tumor burden in 3D. All values on prediction masks are strongly correlated with volume ground-truth, and since the highest coefficients for volumetric measurements are equal to 0.99 (prediction vs ground-truth), the model proved to be robust and accurate in reflecting cancerous changes in the patient data.

### Embodiments

1. In an embodiment, a computer-implemented method of processing CT scan images comprising a liver of a subject to detect and/or predict hepatocellular carcinoma (HCC) in the subject is disclosed, the method comprising the steps of:
   a. receiving at least two CT scan images comprising the liver, optionally comprising receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. cropping, using the obtained reference liver mask, the selected reference CT scan image;
      iv. coregistering the remaining at least one CT scan image with the cropped reference CT scan image;
      v. optionally filtering the reference CT scan image and the coregistered at least one CT scan image.
2. In an embodiment, a computer-implemented method of processing CT scan images comprising a liver of a subject to detect and predict hepatocellular carcinoma (HCC) in the subject is disclosed, the method comprising the steps of:
   a. receiving at least two CT scan images comprising the liver, optionally comprising receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. cropping, using the obtained reference liver mask, the selected reference CT scan image;
      iv. coregistering the remaining at least one CT scan image with the cropped reference CT scan image;
      v. optionally filtering the reference CT scan image and the coregistered at least one CT scan image.
3. In an embodiment, a computer-implemented method of processing CT scan images comprising a liver of a subject to detect or predict hepatocellular carcinoma (HCC) in the subject is disclosed, the method comprising the steps of:
   a. receiving at least two CT scan images comprising the liver, optionally comprising receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. cropping, using the obtained reference liver mask, the selected reference CT scan image;
      iv. coregistering the remaining at least one CT scan image with the cropped reference CT scan image;
      v. optionally filtering the reference CT scan image and the coregistered at least one CT scan image.
4. In an embodiment, a computer-implemented method of processing CT scan images comprising a liver of a subject to detect and/or predict hepatocellular carcinoma (HCC) in the subject is disclosed, the method consisting of the steps of:
   a. receiving at least two CT scan images comprising the liver, optionally comprising receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. cropping, using the obtained reference liver mask, the selected reference CT scan image;
      iv. coregistering the remaining at least one CT scan image with the cropped reference CT scan image;
      v. optionally filtering the reference CT scan image and the coregistered at least one CT scan image.
5. In an embodiment, a computer-implemented method of processing CT scan images comprising a liver of a subject to detect and/or predict hepatocellular carcinoma (HCC) in the subject is disclosed, the method comprising the steps of:
   a. receiving at least two CT scan images comprising the liver, optionally comprising receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. cropping, using the obtained reference liver mask, the selected reference CT scan image;
      iv. coregistering the remaining at least one CT scan image with the cropped reference CT scan image;
      v. filtering the reference CT scan image and the coregistered at least one CT scan image.
6. In an embodiment, a computer-implemented method of processing CT scan images comprising a liver of a subject to detect and predict hepatocellular carcinoma (HCC) in the subject is disclosed, the method comprising the steps of:
   a. receiving at least two CT scan images comprising the liver, optionally comprising receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. cropping, using the obtained reference liver mask, the selected reference CT scan image;
      iv. coregistering the remaining at least one CT scan image with the cropped reference CT scan image;
      v. filtering the reference CT scan image and the coregistered at least one CT scan image.
7. In an embodiment, a computer-implemented method of processing CT scan images comprising a liver of a subject to detect or predict hepatocellular carcinoma (HCC) in the subject is disclosed, the method comprising the steps of:
   a. receiving at least two CT scan images comprising the liver, optionally comprising 855 receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. cropping, using the obtained reference liver mask, the selected reference CT scan image;
      iv. coregistering the remaining at least one CT scan image with the cropped reference CT scan image;
      v. filtering the reference CT scan image and the coregistered at least one CT scan image.
8. In an embodiment, a computer-implemented method of processing CT scan images comprising a liver of a subject to detect and/or predict hepatocellular carcinoma (HCC) in the subject is disclosed, the method comprising the steps of:
   a. receiving at least two CT scan images comprising the liver, optionally comprising receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. coregistering, using the reference liver mask, the remaining at least one CT scan image with the reference CT scan image;
      iv. optionally filtering the reference CT scan image and the coregistered at least one CT scan image.
9. In an embodiment, a computer-implemented method of processing CT scan images comprising a liver of a subject to detect and predict hepatocellular carcinoma (HCC) in the subject is disclosed, the method comprising the steps of:
   a. receiving at least two CT scan images comprising the liver, optionally comprising receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. coregistering, using the obtained reference liver mask, the remaining at least one CT scan image with the reference CT scan image;
      iv. optionally filtering the reference CT scan image and the coregistered at least one CT scan image.
10. In an embodiment, a computer-implemented method of processing CT scan images comprising a liver of a subject to detect or predict hepatocellular carcinoma (HCC) in the subject is disclosed, the method comprising the steps of:
   a. receiving at least two CT scan images comprising the liver, optionally comprising receiving annotations associated with the received CT scan images; and
   b. processing the received CT scan images, wherein processing comprises:
      i. selecting, from the received CT scan images, a reference CT scan image;
      ii. obtaining a reference liver mask for the selected reference CT scan image;
      iii. coregistering, using the obtained reference liver mask, the remaining at least one CT scan image with the reference CT scan image;
      iv. optionally filtering the reference CT scan image and the coregistered at least one CT scan image.
11. In an embodiment, the method of any preceding embodiments is disclosed, wherein the step of receiving at least two CT scan images comprising the liver comprises receiving a CT scan image in arterial phase comprising the liver and a CT scan image in venous phase comprising the liver.
12. In an embodiment, the method of any preceding embodiments is disclosed, wherein the step of receiving at least two CT scan images comprising the liver comprises receiving a CT scan image in arterial phase and a CT scan image in venous phase.
13. In an embodiment, the method of any preceding embodiments is disclosed, wherein the step of receiving at least two CT scan images comprising the liver comprises receiving a CT scan image in arterial phase, a CT scan image in venous phase and a CT scan image in pre-contrast phase.
14. In an embodiment, the method of any preceding embodiments is disclosed, wherein the step of receiving at least two CT scan images comprising the liver comprises receiving at least two CT scan images comprising the whole liver.
15. In an embodiment, the method of any preceding embodiments is disclosed, wherein the step of receiving at least two CT scan images comprising the liver comprises receiving at least two CT scan images comprising a fraction of the liver.
16. In an embodiment, the method of any preceding embodiments is disclosed, wherein the step of receiving at least two CT scan images comprising the liver comprises receiving at least one CT scan image comprising the whole liver and at least one CT scan image comprising a fraction of the liver.
17. In an embodiment, the method of any preceding embodiments is disclosed, wherein the step of selecting a reference CT scan comprises selecting, from the received CT scan images, the CT scan image with the highest resolution.
18. In an embodiment, the method of any preceding embodiments is disclosed, wherein the step of selecting a reference CT scan comprises selecting, from the received CT scan images, one of the CT scan images with the highest resolution, preferably the CT scan image with the highest resolution.
19. In an embodiment, the method of any preceding embodiments is disclosed, wherein the step of obtaining a reference liver mask for the selected reference CT scan image further comprises dilating the reference liver mask.
20. In an embodiment, the method of any preceding embodiments is disclosed, wherein the step of obtaining a reference liver mask for the selected reference CT scan image further comprises dilating the reference liver mask, and wherein dilating the reference mask comprises selecting neighbouring voxels to reference liver mask and identifying said neighbouring voxels as comprised in the reference liver mask.
21. In an embodiment, the method of any preceding embodiments is disclosed, wherein the step of obtaining a reference liver mask for the selected reference CT scan image further comprises dilating the reference liver mask, and wherein dilating the reference mask comprises selecting neighbouring voxels to the reference liver mask and identifying said neighbouring voxels as comprised in the reference liver mask, and wherein neighbouring voxels to the reference liver mask are selected as voxels within a predetermined distance from the reference liver mask and/or within a predetermined number of voxels from the reference liver mask.
22. In an embodiment, the method of any preceding embodiment is disclosed, wherein the step of coregistering the remaining at least one CT scan image with the selected reference CT scan image further comprises cropping, using the obtained reference liver mask, the remaining at least one CT scan image.
23. In an embodiment, a computer-implemented method of obtaining one or more trained machine-learning models to detect and/or predict hepatocellular carcinoma (HCC) in CT scan images comprising a liver is disclosed, the method comprising the steps of:
   a. receiving a training dataset, the training dataset comprising a plurality of CT scan images from a plurality of subjects, the plurality of CT scan images comprising at least two CT scan images from each subject, and wherein the at least two CT scan images from each subject comprise the liver of the subject, and wherein the at least two CT scan images from each subject are processed according to any of the preceding embodiments;
   b. training the one or more machine-learning models using the received training dataset to obtain one or more trained machine-learning models, wherein training the one or more machine-learning models comprises, for each processed at least two CT scan images from each subject:
      i. segmenting objects of interest within the liver; and/or
      ii. calculating at least one probability map associated with the liver of the subject;
   c. optionally outputting the one or more trained machine-learning models.
24. In an embodiment, a computer-implemented method of obtaining one or more trained machine-learning models to detect and predict hepatocellular carcinoma (HCC) in CT scan images comprising a liver is disclosed, the method comprising the steps of:
   a. receiving a training dataset, the training dataset comprising a plurality of CT scan 970 images from a plurality of subjects, the plurality of CT scan images comprising at least two CT scan images from each subject, and wherein the at least two CT scan images from each subject comprise the liver of the subject, and wherein the at least two CT scan images from each subject are processed according to any of embodiments 1-22;
   b. training the one or more machine-learning models using the received training dataset to obtain one or more trained machine-learning models, wherein training the one or more machine-learning models comprises, for each processed at least two CT scan images from each subject:
      i. segmenting objects of interest within the liver; and/or
      ii. calculating at least one probability map associated with the liver of the subject;
   c. optionally outputting the one or more trained machine-learning models.
25. In an embodiment, a computer-implemented method of obtaining one or more trained machine-learning models to detect or predict hepatocellular carcinoma (HCC) in CT scan images comprising a liver is disclosed, the method comprising the steps of:
   a. receiving a training dataset, the training dataset comprising a plurality of CT scan images from a plurality of subjects, the plurality of CT scan images comprising at least two CT scan images from each subject, and wherein the at least two CT scan images from each subject comprise the liver of the subject, and wherein the at least two CT scan images from each subject are processed according to any of embodiments 1-22;
   b. training the one or more machine-learning models using the received training dataset to obtain one or more trained machine-learning models, wherein training the one or more machine-learning models comprises, for each processed at least two CT scan images from each subject:
      i. segmenting objects of interest within the liver; and/or
      ii. calculating at least one probability map associated with the liver of the subject;
   c. optionally outputting the one or more trained machine-learning models.
26. In an embodiment, a computer-implemented method of obtaining one or more trained machine-learning models to detect and/or predict hepatocellular carcinoma (HCC) in CT scan images comprising a liver is disclosed, the method comprising the steps of:
   a. receiving a training dataset, the training dataset comprising a plurality of CT scan images from a plurality of subjects, the plurality of CT scan images comprising at least two CT scan images from each subject, and wherein the at least two CT scan images from each subject comprise the liver of the subject, and wherein the at least two CT scan images from each subject are processed according to any of embodiments 1-22;
   b. training the one or more machine-learning models using the received training dataset to obtain one or more trained machine-learning models, wherein training the one or more machine-learning models comprises, for each processed at least two CT scan images from each subject:
      i. segmenting objects of interest within the liver; and
      ii. calculating at least one probability map associated with the liver of the subject;
   c. optionally outputting the one or more trained machine-learning models.
27. In an embodiment, a computer-implemented method of obtaining one or more trained machine-learning models to detect and/or predict hepatocellular carcinoma (HCC) in CT scan images comprising a liver is disclosed, the method comprising the steps of:
   a. receiving a training dataset, the training dataset comprising a plurality of CT scan images from a plurality of subjects, the plurality of CT scan images comprising at least two CT scan images from each subject, and wherein the at least two CT scan images from each subject comprise the liver of the subject, and wherein the at least two CT scan images from each subject are processed according to any of embodiments 1-22;
   b. training the one or more machine-learning models using the received training dataset to obtain one or more trained machine-learning models, wherein training the one or more machine-learning models comprises, for each processed at least two CT scan images from each subject:
      i. segmenting objects of interest within the liver; or
      ii. calculating at least one probability map associated with the liver of the subject;
   c. optionally outputting the one or more trained machine-learning models.
28. In an embodiment, a computer-implemented method of obtaining one or more trained machine-learning models to detect and/or predict hepatocellular carcinoma (HCC) in CT scan images comprising a liver is disclosed, the method comprising the steps of:
   a. receiving a training dataset, the training dataset comprising a plurality of CT scan images from a plurality of subjects, the plurality of CT scan images comprising at least two CT scan images from each subject, and wherein the at least two CT scan images from each subject comprise the liver of the subject, and wherein the at least two CT scan images from each subject are processed according to any of embodiments 1-22;
   b. training the one or more machine-learning models using the received training dataset to obtain one or more trained machine-learning models, wherein training the one or more machine-learning models comprises, for each processed at least two CT scan images from each subject:
      i. segmenting objects of interest within the liver; and
      ii. calculating at least one probability map associated with the liver of the subject;
   c. outputting the one or more trained machine-learning models.
29. In an embodiment, the method of any of embodiments 23-28 is disclosed, wherein the step of training the one or more machine-learning models using the received training dataset comprises training a single machine-learning model using the training dataset, training a single machine-learning model using one or more of a plurality of subsets of the training dataset, training multiple machine-learning models using the received training dataset, training multiple machine-learning models using one or more of a plurality of subsets of the training dataset.
30. In an embodiment, the method of any of embodiments 23-28 is disclosed, wherein the step of training the one or more machine-learning models using the received training dataset comprises training a single machine-learning model using the training dataset.
31. In an embodiment, the method of any of embodiments 23-28 is disclosed, wherein the step of training the one or more machine-learning models using the received training dataset comprises training a single machine-learning model using one or more of a plurality of subsets of the training dataset.
32. In an embodiment, the method of any of embodiments 23-28 is disclosed, wherein the step of training the one or more machine-learning models using the received training dataset comprises training multiple machine-learning models using the received training dataset.
33. In an embodiment, the method of any of embodiments 23-28 is disclosed, wherein the step of training the one or more machine-learning models using the received training dataset comprises training multiple machine-learning models using one or more of a plurality of subsets of the training dataset.
34. In an embodiment, the method of any of embodiments 23-33 is disclosed, wherein the step of segmenting objects of interest comprises segmenting active HCC tumor lesions, whole tumor lesions, necrosis, cysts, chemoembolizations, or any combination thereof.
35. In an embodiment, the method of any of embodiments 23-34 is disclosed, wherein the step of segmenting objects of interest further comprises detecting the segmented objects of interest.
36. In an embodiment, the method of any of embodiments 23-35 is disclosed, wherein the one or more machine-learning models are nn-UNets models.
37. In an embodiment, the method of any of embodiments 23-36 is disclosed, further comprising normalizing the processed CT scan images, wherein normalizing comprises scaling the CT scan images using CT scan image intensity, performing a z-score normalization, or any combination thereof.
38. In an embodiment, the method of any of embodiments 23-36 is disclosed, further comprising normalizing the processed CT scan images, wherein normalizing comprises scaling the CT scan images using CT scan image intensity.
39. In an embodiment, the method of any of embodiments 23-36 is disclosed, further comprising normalizing the processed CT scan images, wherein normalizing comprises performing a z-score normalization.
40. In an embodiment, a computer-implemented method of using one or more machine-learning models, trained according to any of embodiments 23-39, to detect and/or predict hepatocellular carcinoma (HCC) in CT scan images comprising a liver of a subject is disclosed, the method comprising the steps of:
   a. receiving at least two CT scan images comprising the liver, processed according to any one of embodiments 1-22;
   b. segmenting objects of interest within the liver; and/or
   c. calculating at least one probability map associated with the liver of the subject.
41. In an embodiment, a computer-implemented method of using one or more machine-learning models, trained according to any of embodiments 23-39, to detect and predict hepatocellular carcinoma (HCC) in CT scan images comprising a liver of a subject is disclosed, the method comprising the steps of:
   a. receiving at least two CT scan images comprising the liver, processed according to any one of embodiments 1-22;
   b. segmenting objects of interest within the liver; and/or
   c. calculating at least one probability map associated with the liver of the subject.
42. In an embodiment, a computer-implemented method of using one or more machine-learning models, trained according to any of embodiments 23-39, to detect or predict hepatocellular carcinoma (HCC) in CT scan images comprising a liver of a subject is disclosed, the method comprising the steps of:
   a. receiving at least two CT scan images comprising the liver, processed according to any one of embodiments 1-22;
   b. segmenting objects of interest within the liver; and/or
   c. calculating at least one probability map associated with the liver of the subject.
43. In an embodiment, a computer-implemented method of using one or more machine-learning models, trained according to any of embodiments 23-39, to detect and/or predict hepatocellular carcinoma (HCC) in CT scan images comprising a liver of a subject is disclosed, the method comprising the steps of:
   a. receiving at least two CT scan images comprising the liver, processed according to any one of embodiments 1-22;
   b. segmenting objects of interest within the liver; and
   c. calculating at least one probability map associated with the liver of the subject.
44. In an embodiment, a computer-implemented method of using one or more machine-learning models, trained according to any of embodiments 23-39, to detect and/or predict hepatocellular carcinoma (HCC) in CT scan images comprising a liver of a subject is disclosed, the method comprising the steps of:
   a. receiving at least two CT scan images comprising the liver, processed according to any one of embodiments 1-22;
   b. segmenting objects of interest within the liver; or
   c. calculating at least one probability map associated with the liver of the subject.
45. In an embodiment, the method of any of embodiments 40-44 is disclosed, wherein objects of interest within the liver comprise active HCC tumor lesions, whole tumor lesions, necrosis, cysts, chemoembolizations, or any combination thereof.
46. In an embodiment, a method of diagnosing or monitoring HCC in a subject is disclosed, the method comprising using the method of any preceding embodiments.
47. In an embodiment, a method of diagnosing HCC in a subject is disclosed, the method comprising:
   a. receiving at least two CT scan images comprising the liver of the subject;
   b. processing the received CT scan images, wherein processing comprises:
      i. coregistering the received CT scan images;
   c. segmenting object of interest within the liver; and/or
   d. calculating at least one probability map associated with the liver of the subject;
   e. providing a diagnosis of HCC for the subject.
48. In an embodiment, a system is disclosed, comprising:
   a. a processor;
   b. a computer readable medium comprising instructions that, when executed by the processor, cause the processor to perform the steps of the method of any preceding embodiments;
   c. optionally a CT scan images acquisition means.
49. In an embodiment, a system is disclosed, comprising:
   a. a processor;
   b. a computer readable medium comprising instructions that, when executed by the processor, cause the processor to perform the steps of the method of any preceding embodiments;
   c. a CT scan images acquisition means.
50. The invention as hereinbefore described.

### REFERENCES

Gaillard, F. (2021), Hepatocellular carcinoma, Radiology Reference Article, Radiopeadia.org.
Finn, R. S. et al (2020), Atezolizumab plus Bevacizumab in Unresectable Hepatocellular Carcinoma, N. Engl. J. Med., 382, 1894-1905.

TABLE I
the CT scan acquisition guidelines used in the clinical trial.

| | | Scan 1 | Scan 2 | |
|---|---|---|---|---|
| Scan Phase/Delay | Pre-contrast | Arterial Phase | Portal Venous | Delayed Phase |
| | (Optional) | (20-25 seconds | Phase (60-70 | (Min. 120 |
| | | post injection) | seconds post | seconds post |
| | | | injection) | injection) |
| Scan | Entire Liver | Entire Liver | Lung apices to | Entire Liver |
| Locations/Coverage | | | symphysis | |
| | | | pubis | |
| Patient Orientation | Supine | Supine | Supine | Supine |
| Breath-hold Details | Single | Single | Single | Single |
| Scan FOV | Large | Large | Large | Large |
| Display FOV | Unique to | Unique to | Unique to | Unique to |
| | patient size | patient size | patient size | patient size |
| Slice thickness | ≤5 mm | ≤5 mm | ≤5 mm | ≤5 mm |
| Reconstruction | ≤5 mm | ≤5 mm | ≤5 mm | ≤5 mm |
| interval (distance | | | | |
| between slice | | | | |
| locations) | | | | |
| Gap (slice spacing) | None (i.e. | None (i.e. | None (i.e. | None (i.e. |
| | contiguous) | contiguous) | contiguous) | contiguous) |

TABLE II
patients stratified in 5 folds as a result
of the stratification process described.

| | Vₜ | Vₜ | Nₜ | Nₜ | Vₚᵥ | Vₚᵥ | V_{c} | V_{c} |
|---|---|---|---|---|---|---|---|---|
| Subset | Small | Big | Small | Big | Small | Big | Small | Big |
| Fold 1 | 14 | 18 | 18 | 14 | 26 | 6 | 24 | 8 |
| Fold 2 | 15 | 17 | 18 | 14 | 26 | 6 | 24 | 8 |
| Fold 3 | 17 | 15 | 18 | 14 | 26 | 6 | 25 | 7 |
| Fold 4 | 17 | 15 | 18 | 14 | 26 | 6 | 25 | 7 |
| Fold 5 | 17 | 15 | 16 | 16 | 26 | 6 | 25 | 7 |
| Test | 11 | 9 | 10 | 10 | 18 | 2 | 6 | 14 |

TABLE III
results for three classes of models: Whole Tumors (WT), HCC, HCC + Necrosis (HCC + NEC).

| | | | | | | | AvgBlob | | |
|---|---|---|---|---|---|---|---|---|---|
| | | | | | Hausdorff | | Jaccard | AvgBlob | AvgBlob |
| Model | Class | DICE | Sensitivity | Specificity | 3D 95 | IoU | Index | Precision | Recall |
| WT | WT | 0.7735 | 0.7542 | 0.9971 | 24.4705 | 0.6540 | 0.3822 | 0.5060 | 0.5063 |
| HCC | HCC | 0.7347 | 0.7211 | 0.9965 | 19.2424 | 0.6014 | 0.3777 | 0.5069 | 0.4659 |
| HCC + NEC | HCC | 0.7345 | 0.7065 | 0.9967 | 18.0339 | 0.5981 | 0.3062 | 0.4615 | 0.3674 |
| HCC + NEC | NEC | 0.4029 | 0.4203 | 0.9991 | 22.8527 | 0.2891 | 0.1692 | 0.2284 | 0.2541 |

TABLE IV
results of Pearson correlation coefficients for the HCC model.

| | Volume | RECIST | Volume |
|---|---|---|---|
| Measurements | (GT) | (HCC + NEC) | (HCC + NEC) |
| RECIST (GT) | 0.7869 | 0.8815 | 0.7663 |
| Volume (GT) | | 0.9040 | 0.9886 |
| RECIST (HCC + NEC) | | | 0.9059 |

TABLE V
results of Pearson correlation coefficients
for the HCC + NEC model.

| | Volume | RECIST | Volume |
|---|---|---|---|
| Measurements | (GT) | (HCC + NEC) | (HCC + NEC) |
| RECIST (GT) | 0.7869 | 0.8902 | 0.7669 |
| Volume (GT) | | 0.9089 | 0.9869 |
| RECIST (HCC + NEC) | | | 0.9002 |

TABLE VI
results of Pearson correlation coefficients
for different measurements.

| Measurements | Volume (GT) | RECIST (WT) | Volume (WT) |
|---|---|---|---|
| RECIST (GT) | 0.8222 | 0.9059 | 0.7959 |
| Volume (GT) | | 0.8859 | 0.9895 |
| RECIST (WT) | | | 0.8730 |

1. A computer-implemented method of processing CT scan images comprising a liver of a subject to detect and/or predict hepatocellular carcinoma (HCC) in the subject, the method comprising the steps of:
a. receiving at least two CT scan images comprising the liver, optionally comprising receiving annotations associated with the received CT scan images; and
b. processing the received CT scan images, wherein processing comprises:
i. selecting, from the received CT scan images, a reference CT scan image;
ii. obtaining a reference liver mask for the selected reference CT scan image;
iii. cropping, using the obtained reference liver mask, the selected reference CT scan image;
iv. coregistering the remaining at least one CT scan image with the cropped reference CT scan image;
v. optionally filtering the reference CT scan image and the coregistered at least one CT scan image.

2. The method of claim 1, wherein the step of receiving at least two CT scan images comprises receiving a CT scan image in arterial phase and a CT scan image in venous phase.

3. The method of claim 1, wherein the step of selecting a reference CT scan image comprises selecting, from the received CT scan images, the CT scan image with the highest resolution.

4. The method of claim 1, wherein the step of obtaining a reference liver mask for the selected reference CT scan image further comprises dilating the reference liver mask.

5. The method of claim 1, wherein the step of coregistering the remaining at least one CT scan image with the selected reference CT scan image comprises performing a rigid coregistration and/or a deformable coregistration and/or any combination thereof.

6. The method of claim 1, wherein the step of coregistering the remaining at least one CT scan image with the selected reference CT scan image further comprises cropping, using the obtained reference liver mask, the remaining at least one CT scan image.

7. A computer-implemented method of obtaining one or more trained machine-learning models to detect and/or predict hepatocellular carcinoma (HCC) in CT scan images comprising a liver, the method comprising the steps of:
a. receiving a training dataset, the training dataset comprising a plurality of CT scan images from a plurality of subjects, the plurality of CT scan images comprising at least two CT scan images from each subject, and wherein the at least two CT scan images from each subject comprise the liver of the subject, and wherein the at least two CT scan images from each subject are processed according to claim 1;
b. training the one or more machine-learning models using the received training dataset to obtain one or more trained machine-learning models, wherein training the one or more machine-learning models comprises, for each processed at least two CT scan images from each subject:
i. segmenting objects of interest within the liver; and/or
ii. calculating at least one probability map associated with the liver of the subject;
c. optionally outputting the one or more trained machine-learning models.

8. The method of claim 7, wherein the step of training the one or more machine-learning models using the received training dataset comprises training a single machine-learning model using the training dataset, training a single machine-learning model using one or more of a plurality of subsets of the training dataset, training multiple machine-learning models using the training dataset, training multiple machine-learning models using one or more of a plurality of subsets of the training dataset.

9. The method of claim 7, wherein segmenting objects of interest further comprises detecting the segmented objects of interest.

10. The method of claim 7, wherein the one or more machine-learning models are nn-UNets models.

11. The method of claim 7, further comprising normalizing the processed CT scan images, wherein normalizing comprises scaling the CT scan images using CT scan image intensity, performing a z-score normalization, or any combination thereof.

12. A computer-implemented method of using one or more machine-learning models, trained according to claim 7, to detect and/or predict hepatocellular carcinoma (HCC) in CT scan images comprising a liver of a subject, the method comprising the steps of:
a. receiving at least two CT scan images comprising the liver, processed according to claim 1;
b. segmenting objects of interest within the liver; and/or
c. calculating at least one probability map associated with the liver of the subject.

13. The method of claim 11, wherein objects of interest within the liver comprise active HCC tumor lesions, whole tumor lesions, necrosis, cysts, chemoembolizations, or any combination thereof.

14. A method of diagnosing or monitoring HCC in a subject, the method comprising using the method of any preceding claims.

15. A system comprising:
a. a processor; and
b. a computer readable medium comprising instructions that, when executed by the processor, cause the processor to perform the steps of the method of claim 1;
optionally a CT scan images acquisition means.
